(19) United States
(12) Patent Application Publication
(10) Pub. No.: US 2004/0009300 A1
(43) Pub. Date: Jan. 15, 2004

(54) Method for pretreating and subsequently coating metallic surfaces with paint-type coating prior to forming and use og sybstrates coated in this way

(76) Inventors: Toshiaki Shimakura, Fchikawa-shi (JP); Klaus Bittner, Frankfurt (DE); Heribert Domes, Weilmunster (DE); Hardy Wietzoreck, Frankfurt (DE); Christian Jung, Oberhaid (DE)

Correspondence Address: FULBRIGHT & JAWORSKI, LLP, 666 FIFTH AVE, NEW YORK, NY, 10103-3198, US

(21) Appl. No.: 10/362,388

(22) PCT Filed: Oct. 10, 2001
(86) PCT No.: PCT/EP01/11738

(30) Foreign Application Priority Data
Oct. 11, 2000 (DE) 100 50 535.5
Mar. 6, 2001 (DE) 101 10 830.3
Apr. 21, 2001 (DE) 101 19 607.7

(51) Int. Cl. B05D 3/02; B05D 1/36

(52) U.S. Cl. 427/407.1; 427/385.5; 427/402

(57) ABSTRACT

The invention relates to a method for coating a metallic strip. The strip or optionally, the strip sections produced from said strip in the subsequent process, is/are coated first with at least one anticorrosion layer and then with at least one layer of a paint-like coating containing polymers and/or with at least one paint coating. After being coated with at least one anticorrosion layer or after being coated with at least one layer of a paint-like coating and/or with at least one paint coating, the strip is divided into strip sections. The coated strip sections are then formed, joined and/or coated with at least one (other) paint-like coating and/or paint coating. At least one of the anticorrosion layers is formed by coating the surface with an aqueous dispersion containing the following in addition to water: a) at least one organic film former containing at least one water-soluble or water-dispersed polymer; b) a quantity of cations and/or hexa- or tetrafluoro complexes of cations chosen from a group consisting of titanium, zirconium, hafnium, silicon, aluminium and boron; and c) at least one inorganic compound in particle form with an average particle diameter measured on a scanning electron microscope of 0.005 to 0.2 μm. The clean metallic surface is brought into contact with the aqueous composition and a film containing particles is formed on the metallic surface, this film then being dried and optionally also hardened, the dried and optionally, also hardened film having a layer thickness of 0.01 to 10 μm.

The invention relates to a method of coating metallic surfaces and also to the use of the coated substrates produced by the method of the invention in particular in vehicle construction, especially in the line manufacture of automobiles, and for the production of components or bodywork parts or premounted elements in the vehicle, air travel or space travel industry. It relates in particular to new possibilities for the preparation and assembly of motor vehicles which no longer involve the current standard practice of assembling the various parts of the body, cleaning and phosphating them and only then painting them with the paint system as a whole.

There is a need for the development of an improved anticorrosion coating in the form of a pretreatment coating upstream of the coating operation, using for example paint or a paintlike layer, on the one hand, and for even greater rationalization of the manufacture of vehicle bodies and their individual parts and also of paneling for vehicles and aircraft, on the other hand.

The anticorrosion layer(s) ought to be readily formable together with the paint or a paintlike layer and ought also to exhibit, after forming, effective corrosion protection and effective paint adhesion. Additionally, depending on the joining technique, it may be necessary for these layers to be readily clinchable as well without showing a greater tendency toward corrosion as a result.

For producing paint-coated metal sheets there are already methods similar to the production methods for metal sheets precoated on the strip, which are used for household appliances, metal architectural panels, and furniture. The requirements imposed on these sheets, however, are much less stringent than the requirements in particular in automobile engineering and aircraft construction. This is because the requirements in the vehicle, air travel or space industry in terms of the strength of the coated sheets, the joining technologies, the paint system, and the properties of the paint layers, such as brightness, gloss, corrosion resistance, scratch resistance, paint adhesion, and stonechip resistance, are markedly different and influence the complex manufacturing process. The high-grade properties of these sheets must still be sufficiently high in the region of the formed and joined portions in particular. Normally, the same exacting requirements as those imposed at present are imposed on a different manufacturing process and a different layer structure, even when individual layers are thinner than 4 μm. The composition of the coating used for this purpose, comprising polymers and particles, is also novel, to the knowledge of the applicant.

The basecoat for metal architectural panels on the outside presently often contains chromate, in order to provide increased corrosion resistance at a relatively low layer thickness; applied to the basecoat there is normally a topcoat with a thickness in the range from 10 to 20 μm. The same or similar basecoats as on the facing side are often applied to the inside of metal architectural panels, as a reverse-face coating, with a thickness in the range from 6 to 15 μm, as a single paint layer. To date, however, to the knowledge of the applicant, there has been no use of UV-cured paint materials in the coating of strips in the household appliance and architectural segments.

The strip line which is utilized in each case may be a galvanizing line, a coil coating line and/or another kind of coating line, such as, for example, a painting line in, for example, an automobile plant, on which cut strip which has been pretreated beforehand on a strip line is painted with a paint and/or with a paintlike coating.

By prephosphating is meant a temporary protection of metallic surfaces, it being possible for the substrates thus coated to be subsequently subjected, where appropriate, to oiling, temporary storage, forming, joining (after deoiling) by clinching, adhesive bonding and/or welding, for example, and/or pretreated again with phosphate, for example, before the paint system is applied.

Pretreatment prior to painting is nowadays carried out, particularly in the European automobile industry, sometimes without deliberate addition of chromium and sometimes with addition of chromium. In principle, however, it is preferred to operate without chromium or substantially without chromium, in particular without chromium to the extent that no chromium is deliberately added, in order to avoid this toxic heavy metal. Nevertheless, the addition of chromium has a particular corrosion protection effect, given that a self-healing effect may come about at a site which has been damaged. The pretreatment solutions are preferably also free from or contain low levels in each case of cobalt, copper, nickel and/or other heavy metals. Amounts of nickel in particular, however, are still particularly advantageous and are therefore virtually always present in phosphate coats, for example. The pretreatment solutions can be applied either by the rinse method or by the no-rinse method. In the case of the rinse method, the application of the solution, which can take place in particular by spraying and/or dipping and during which the pretreatment layer is formed, is followed by rinsing. In the case of the no-rinse method, the solution is applied with a roll coater, for example, and is dried immediately without rinsing.

By a basecoat is meant a paint or a paintlike coating which replaces the cathodic dip coat (electrocoat) that is commonly used in bodywork construction. It may be a primer, in particular a lubricant primer, welding primer or pretreatment primer, or another kind of coating, based for example on silane/siloxane. When necessary, an intermediate paint layer may be applied between the basecoat and the surfacer (i.e., color coating). The surfacer is normally followed by at least one clearcoat, which intensifies the brightness and is also referred to as the topcoat.

The coating which is developed with a lubricant primer can be formed very effectively and easily owing to the good slip properties, its low friction, and its flexibility. A welding primer and the coating produced from it includes such a high fraction of electrically conductive substance, in particular of electrically conductive particles, that two metal sheets can be welded together without substantially increased effort even when this involves contacting through two paintlike coats. A pretreatment primer is a primer or a corresponding coating which may also replace the corrosion protection properties of a pretreatment layer. All of these are paintlike coatings.

The processes used most frequently to date for the surface treatment or pretreatment prior to painting of metals, particularly of metal strip, are based on the use of chromium(VI) compounds together with diverse additives. Owing to the toxicological and environmental risks which such processes entail and, moreover, owing to the foreseeable statutory restrictions on the use of chromate-containing processes, the search has been on for some time already for alternatives to these processes in all fields of metal surface treatment.

Resin mixtures are known for which resins are blended with inorganic acids in order thus to obtain a pickling attack as well and hence a better contact of the resin coat directly with the metallic surface. These compositions have the drawback that, owing to the pickling attack, contamination occurs during the contacting of the treatment liquid (dispersion) to the substrate. This leads to the accumulation of metals in the treatment liquid and, as a result, to a permanent change in the chemical composition of the treatment liquid, thereby significantly impairing the corrosion protection. These metals are dissolved by the pickling attack out of the metallic surface of the substrates to be treated.

Another drawback is that, especially in the case of aluminum and aluminum-containing alloys, the surfaces darken, discoloring in certain circumstances to a dark gray to anthracite color. The darkened metal surfaces cannot be used for decorative applications, since the discoloration is undesirable on esthetic grounds alone.

Depending on the thickness of the applied layer, the darkening is visible with varying intensity.

The processes most frequently employed to date for the surface treatment of metals, especially of metal strip, are based on the use of chromium(VI) compounds together with diverse additives. Owing to the toxicological and environmental risks which accompany such processes and, moreover, owing to the foreseeable statutory restrictions on the use of chromate-containing processes, the search has been on for some time already for alternatives to these processes in all fields of metal surface treatment.

EP-A-0 713 540 describes an acidic, aqueous composition for treating metal surfaces, which comprises complex fluoride based on Ti, Zr, Hf, Si, Al and/or B, cations of Co, Mg, Mn, Zn, Ni, Sn, Cu, Zr, Fe and/or Sr, inorganic phosphates and/or phosphonates, and also polymers, in a ratio of polymers to complex fluorides in the range from 1:2 to 3:1. In every example, however, this publication describes an addition of phosphate or phosphonate.

EP-A-0 181 377 or WO 85/05131 specifies aqueous compositions based a) on complex fluoride of B, Si, Ti or Zr, of hydrofluoric acid and/or of fluoride, b) on salts of Co, Cu, Fe, Mn, Ni, Sr and/or Zn, c) on a sequesterant selected from nitrilotriacetic acid NTA, ethylenediaminetetraacetic acid EDTA, gluconic acid, citric acid and derivatives thereof or alkali metal salts or ammonium salts, and d) on a polymer of polyacrylic acid, polymethacrylic acid or the C₁ to C₈ alkanol esters thereof. This publication, however, does not teach the use of finely divided particles.

WO-A-93/20260 relates to a process for producing a coating for an aluminum-rich metallic surface with an aqueous mixture without phase separation, which comprises complex fluoride based on Ti, Zr, Hf, Si, Ge, Sn and/or B and also a dissolved and/or dispersed compound based on Ti, Zr, Hf, Al, Si, Ge, Sn and/or B. The specific polymer which is added in this case is based on 4-hydroxostyrene and phenolic resin and is yellowish and in certain circumstances toxic. It serves as a film former and adhesion promoter. The examples cite aqueous compositions containing hexafluorotitanic acid, SiO₂ particles, and said polymer in a range from 5.775 to 8.008% by weight. Furthermore, this publication protects a method of coating a metallic surface with said aqueous mixture only by contacting and drying and also, subsequently, brief contacting with such a mixture at temperatures in the region of 25 and 90° C. No coat thickness is cited for the coating applied using this aqueous composition. This thickness can, however, be stated from the stated layer deposits of titanium, which amount to 22 to 87 mg/m² and thus are roughly ten times as great as in the case of the inventive examples of this application. This is in agreement with the assumption that, owing to the high proportion of polymers in the suspension and owing to the very high concentration of the suspension, it also has a heightened viscosity, so that the suspension also forms a comparatively thick coating which will probably be situated in the range of a good few μm in thickness. The T-bend data indicated for the T2 bending after boiling are not concretely comparable with the T1 data of this application, but in any case must be estimated to be much poorer, since in the case of T1 bending is carried out by about 1 mm, while in the case of T2 bending is carried out by about 2 mm, as a result of which the loads are much lower.

U.S. Pat. No. 5,089,064 teaches a process for coating aluminum-containing surfaces with an aqueous composition containing 0.01 to 18% by weight of hexafluorozirconic acid, 0.01 to 10% by weight of a specific polymer based on 4-hydroxystyrene and phenolic resin (see also WO-A-93/20260), 0.05 to 10% by weight of SiO₂ particles, if desired, a solvent for dissolving 4-hydroxystyrene-phenolic resin below 50° C., and, if desired, a surfactant, the aqueous composition being applied in a drying process without subsequent rinsing.

WO96/07772 describes a process for the conversion treatment of metallic surfaces with an aqueous composition comprising (A) complex fluorides based on Ti, Zr, Hf, Si, Al and/or B of at least 0.15 M/kg, (B) cations selected from Co, Cu, Fe, Mg, Mn, Ni, Sn, Sr, Zn and/or Zr with a molar ratio of (B) to (A) in the range from 1:5 to 3:1, (C) at least 0.15 Mp/kg of phosphorus-containing oxyanions and/or phosphonates, (D) at least 1% of water-soluble and water-dispersible polymers or of polymer-forming resins, and (E) sufficient free acid to give the aqueous composition a pH in the range from 0.5 to 5.

It is an object of the invention to overcome the drawbacks of the prior art and in particular to propose a method of coating metallic surfaces which is also suitable for high coating speeds, such as are used for strips; which can be employed substantially or entirely free from chromium(VI) compounds; and which can be employed on a large scale.

It is an object of the invention to propose a method of coating metallic substrates which is also suitable for coating onto strips running at speed and with which it is possible to apply at least one organic, sufficiently flexible, and at the same time sufficiently corrosion-resistant coating (basecoat). The coating sequence should also be sufficiently corrosion resistant after deformation. This method ought to be suitable for economic and very environmentally friendly industrial implementation.

A further object was to propose a method for producing parts, in particular for the assembly of automobile bodies with which it is possible to perform a longer part of the manufacturing operation of the parts, where appropriate still in the form of a strip, than was hitherto the case in a strip line.

The object is achieved by a method of coating a metallic strip, the strip, or strip sections produced from it, where appropriate, in the subsequent operation, being first coated with at least one anticorrosion layer and then with at least one layer of a paintlike, polymer-containing layer and/or at least one paint layer, the strip, after coating with at least one anticorrosion layer or after coating with at least one layer of a paintlike coating and/or at least one paint layer, being divided into strip sections, the coated strip sections then being formed, joined and/or coated with at least one (further) paintlike layer and/or paint layer, at least one of the anticorrosion layers being formed by coating the surface with an aqueous dispersion which comprises besides water a) at least one organic film former comprising at least one water-soluble or water-dispersed polymer, b) an amount of cations and/or hexafluoro and/or tetrafluoro complexes of cations selected from the group consisting of titanium, zirconium, hafnium, silicon, aluminum, and boron, and c) at least one inorganic compound in particle form, having an average particle diameter, measured in a scanning electron microscope, in the range from 0.005 up to 0.2 μm diameter, the clean metallic surface being contacted with the aqueous composition, and a particle-containing film being formed on the metallic surface and subsequently dried and, where appropriate, additionally cured, the dried and, where appropriate, additionally cured film having a thickness in the range from 0.01 to 10 μm.

The surfaces coated in these methods are metallic surfaces in particular of aluminum, iron, copper, magnesium, nickel, titanium, tin, zinc or alloys of aluminum, iron, copper, magnesium, nickel, titanium, tin and/or zinc. The aqueous composition used may in this case be substantially or entirely free from chromium(VI) compounds. It may serve for pretreatment prior to a further coating, such as painting, for example, or for the treatment wherein the element to be coated, where appropriate—in particular a strip or strip section—is formed after coating. In particular, however, the intention is that it should serve to form a first and/or second pretreatment layer.

In addition to the abovementioned constituents it may comprise where appropriate at least one organic solvent, where appropriate at least one silane and/or siloxane calculated as silane, where appropriate at least one corrosion inhibitor, and where appropriate at least one chromium(VI) compound.

The thickness of the dried and, where appropriate, also cured film can be approximately determined from the constituents, their density, and the deposits of titanium and/or zirconium on the coated surface, as determined by x-ray fluorescence analysis.

In this context, a standard coil-coating paint F2-647 together with the topcoat paint F5-618 applied to the dried or cured film preferably produces an adhesive strength of not more than 10% of the delaminated area in the case of a T-bend test with a T1 bend in accordance with NCCA.

Both are paints from Akzo Nobel. In a standardized way, for these tests, the primer coating is applied to the coating of the invention with a film thickness of fairly precisely 5 μm, and the topcoat paint is applied to this primer coating in a standardized way with a film thickness of fairly precisely 20 μm. Thereafter a coated strip section is bent around such that at the point of bending the distance between the two sheet-metal halves amounts to exactly one sheet thickness. The sheet thickness of the material used was 0.8 mm. At the bending point, the paint adhesion is then tested by means of tape removal and the result of the test is expressed as the percentage fraction of the delaminated area. The T-bend test can therefore be regarded as a very challenging paint adhesion test for the quality of pretreated and painted metallic sheets with regard to the damage to this coat system in the course of subsequent forming. The area fractions of the delaminated area in the case of the T-bend test are preferably up to 8%, more preferably up to 5%, very preferably up to 2%, the best figures, however, being situated at approximately 0%, so that then, normally, only cracks, but not area delamination, can occur.

The term “clean metallic surface” here denotes an uncleaned metallic surface, e.g., a freshly galvanized surface, on which no cleaning is necessary, or a freshly cleaned metallic surface.

Inventive Composition for Developing a Treatment Layer or Pretreatment Layer and/or a Paintlike Coating:

The organic film former is present in the aqueous composition (bath solution) preferably in an amount of from 0.1 to 100 g/L, more preferably in a range from 0.2 to 30 g/L, very preferably from 0.5 to 10 g/L, in particular from 1 to 4 g/L.

The amount of cations and/or hexafluoro complexes of cations selected from the group of titanium, zirconium, hafnium, silicon, aluminum, and boron in the aqueous composition (bath solution) is preferably from 0.1 to 50 g/L, more preferably from 0.2 to 30 g/L, very preferably from 0.5 to 10 g/L, in particular from 1 to 4 g/L. These figures are based on the amount of the elemental metal. Particular preference is given to cations and/or hexafluoro complexes of titanium and/or zirconium.

The at least one inorganic compound in particle form is present in the aqueous composition (bath solution) preferably in an amount of from 0.1 to 80 g/L, more preferably in a range from 0.2 to 25 g/L, very preferably from 0.5 to 10 g/L, in particular from 1 to 4 g/L.

The ratio of the amounts of cations and/or hexafluoro complexes of cations selected from the group of titanium, zirconium, hafnium, silicon, aluminum, and boron to amounts of organic film former in the aqueous composition (bath solution) may fluctuate within wide ranges; in particular, it can be ≦1:1. This ratio is preferably in a range from 0.05:1 to 3.5:1, more preferably in a range from 0.2:1 to 2.5:1.

The ratio of the amounts of cations and/or hexafluoro complexes of cations selected from the group of titanium, zirconium, hafnium, silicon, aluminum, and boron to amounts of inorganic compounds in particle form in the aqueous composition (bath solution) may fluctuate within wide ranges; in particular, it can be ≦5.5:1. This ratio is preferably in a range from 0.05:1 to 5:1, more preferably in a range from 0.2:1 to 2.5:1.

The ratio of the amounts of organic film former to amounts of inorganic compounds in particle form in the aqueous composition (bath solution) can vary within wide ranges; in particular, it can be <3.8:1. This ratio is preferably situated within a range from 0.05:1 to 3.5:1, more preferably within a range from 0.18:1 to 2.5:1.

The amount of at least one silane and/or siloxane calculated as silane in the aqueous composition (bath solution) is preferably from 0.1 to 50 g/L, more preferably from 0.2 to 35 g/L, very preferably from 0.5 to 20 g/L, in particular from 1 to 10 g/L. An additive of this type can help to improve the adhesion of a subsequently applied organic coating, by reactional functional groups, such as amino or epoxy functions.

The aqueous composition is preferably also free or substantially free from transition metals or heavy metals which are not present in the inorganic compound in particle form in very small particle sizes and/or which are not attached to fluorine in the form, for example, of hexafluoride and/or tetrafluoride and which, however, in that case also do not have to be attached to fluorine. Moreover, the aqueous composition may also be free or substantially free from transition metals or heavy metals which have been deliberately added to the aqueous composition, with the exception of the abovementioned additions in particle form and with the exception of the compounds bonded at least partly to fluoride. In contrast, the aqueous composition may include traces or small amounts of transition metal or heavy metal impurities, which can have been dissolved out of the metallic substrate surface and/or from the bath vessels and/or pipelines as a result of a pickling effect; which have been entrained from upstream baths and/or which originate from impurities in the raw materials. With particular preference the aqueous composition is free or substantially free from lead, cadmium, iron, cobalt, copper, manganese, nickel, zinc and/or tin. It is particularly advisable to use substantially or entirely chromium-free aqueous compositions. The aqueous composition, which is substantially free from chromium(VI) compounds, has a chromium content of only up to 0.05% by weight on chromium-free metallic surfaces, and a chromium content of up to 0.2% by weight on chromium-containing metallic surfaces. The aqueous composition is also preferably free of compounds containing phosphorus, unless they are bound to polymers or are to be substantially bound to polymers.

It is preferred not to add either chromium or phosphate or phosphonate, or amounts of lead, cadmium, iron, cobalt, copper, manganese, nickel, zinc and/or tin deliberately, so that such amounts may occur only as a result of trace impurities, entrainment from upstream baths and/or pipelines, and/or owing to the incipient dissolution of compounds of the surface to be coated. The composition preferably is also free from additions or amounts of hydroxocarboxylic acids such as gluconic acid, for example.

In the case of the method of the invention the organic film former can be present in the form of a solution, dispersion, emulsion, microemulsion and/or suspension.

The organic film former may be or comprise at least one synthetic resin, especially a synthetic resin based on acrylate, polyacrylic, ethylene, polyethylene, polyester, polyurethane, silicone polyester, epoxide, phenol, polystyrene, styrene, urea-formaldehyde, mixtures thereof and/or addition copolymers thereof. The system in question may be a cationically, anionically and/or sterically stabilized synthetic resin or polymer and/or solution thereof.

The organic film former is preferably a synthetic resin mixture and/or an addition copolymer which includes synthetic resin based on acrylate, polyacrylic, ethylene, polyethylene, urea-formaldehyde, polyester, polyurethane, polystyrene and/or styrene, and from which, during or after the emission of water and other volatile constituents, an organic film is formed. The organic film former may comprise synthetic resin and/or polymer based on polyacrylate, polyethyleneimine, polyurethane, polyvinyl alcohol, polyvinylphenol, polyvinylpyrrolidone, polyaspartic acid and/or derivatives thereof and/or copolymers, particularly copolymers with a phosphorus-containing vinyl compound, ethylene-acrylic copolymer, acrylic-modified polyester, acrylic-polyester-polyurethane copolymer and/or styrene acrylate. The synthetic resin or polymer is preferably water-soluble. It preferably contains free acid groups which have not been neutralized, in order to allow attack on the metallic surface.

Very particular preference is given to a synthetic resin based on polyacrylic acid, polyacrylate and/or polyethylene-acrylic acid the latter as a copolymer in particular or to a synthetic resin having a melting point in the range from 40 to 160° C., in particular in the range from 120 to 150° C.

The acid number of the synthetic resin may lie preferably in the range from 5 to 800, more preferably in the range from 50 to 700. The advantage of such synthetic resins lies, in the majority of cases, in that it is unnecessary to provide these synthetic resins and/or polymers with cationic, anionic or steric stabilization. The molecular weight of the synthetic resin and/or of the polymer may lie in the region of at least 1 000 u, preferably from 5 000 to 250-000 u, more preferably in the range from 20 000 to 200 000 u.

The phosphorus content of the aqueous composition is preferably attached substantially or completely to organic, in particular polymeric, compounds, so that the phosphorus content is not bound, or almost not bound, to purely inorganic compounds such as orthophosphates, for example.

On the one hand, the aqueous composition may be such that it contains no corrosion inhibitors, in which case the coatings formed therefrom already acquire outstanding corrosion control. On the other hand, it may also include an amount of in each case at least one corrosion inhibitor. The corrosion inhibitor may contain at least one organic group and/or at least one amino group. It may be an organic compound or an ammonium compound, in particular an amine or an amino compound, such as, for example, an alkanolamine, a TPA-amine complex, a phosphonate, a polyaspartic acid, a thiourea, a Zr ammonium carbonate, benzotriazole, a tannin, an electrically conductive polymer such as a polyaniline, for example, and/or derivatives thereof, as a result of which it is possible to bring about a further marked improvement in corrosion protection. It can be advantageous if the corrosion inhibitor is readily soluble in water and/or readily dispersible in water, in particular at more than 20 g/L. It is preferably present in the aqueous composition in an amount in the range from 0.01 to 50 g/L, more preferably in the range from 0.3 to 20 g/L, very preferably in the range from 0.5 to 10 g/L. An addition of at least one corrosion inhibitor is particularly important for electro-lytically galvanized steel sheets. The addition of a corrosion inhibitor may help to achieve the requisite reliability for corrosion stability in mass production.

Furthermore, it was found that the addition of manganese ions added, for example, as the metal in acidic solution or in the form of manganese carbonate to the compositions cited in the examples improved the alkali resistance. In this context, in particular, an addition of Mn ions with an amount in the range from 0.05 to 10 g/L proved very appropriate. Surprisingly, as a result of this addition of manganese, there was a perceptible improvement not only in the alkali resistance but also in the general corrosion stability and in the paint adhesion.

Furthermore, it is preferred for the aqueous, fluorine-containing composition to include a high or very high fraction of complex fluoride, in particular 50 to 100% by weight based on the fluorine content. The fluorine content in the form of complexes and free ions in the aqueous composition (bath solution) is preferably in total 0.1 to 14 g/L, more preferably 0.15 to 8 g/L, in particular 0.2 to 3 g/L.

It is also preferred for the aqueous composition to include an amount of zirconium as sole cation or in a relatively high proportion, i.e., at least 30% by weight, based on the mixture of cations selected from the group of titanium, zirconium, hafnium, silicon aluminum and boron. The amount of such cations in the aqueous composition (bath solution) is preferably in total 0.1 to 15 g/L, more preferably 0.15 to 8 g/L, in particular 0.2 to 3 g/L. The amount of zirconium and/or titanium in the aqueous composition is preferably in total 0.1 to 10 g/L, more preferably 0.15 to 6 g/L, in particular 0.2 to 2 g/L. It was found that none of the cations selected from this group provides better results in terms of corrosion control and paint adhesion than zirconium, which is present fractionally or alone selected from these cations.

If there is a marked excess of fluoride in relation to the amount of cations of this kind, in particular more than 35 mg/L free fluoride, then the pickling effect of the aqueous composition is intensified. An amount of 35 to 350 mg/L free fluoride in particular may help to provide better control of the thickness of the coating produced. If there is a marked deficit of fluoride in relation to the amount of such cations, then the pickling effect of the aqueous composition is markedly reduced and a thicker coating will frequently be formed, which in some cases may even be too thick and may readily undergo filiform corrosion, and, in addition, possesses poorer paint adhesion.

The composition of the organic film former may also be such that it contains (only) water-soluble synthetic resin and/or polymer, especially resin and/or polymer stable in solutions with pH values <5.

The organic film former preferably contains synthetic resin or polymer containing a relatively high fraction of carboxyl groups. Additionally it is also possible to use synthetic resins which become soluble in water or dispersible in water only following reaction with a basic compound such as ammonia, amines and/or alkali metal compounds.

In the case of the method of the invention it can be preferable for the aqueous composition to comprise at least one partly hydrolyzed or fully hydrolyzed silane.

This then offers the advantage that, in the case of many paint systems, improved adhesion is obtained. The silane may be an acyloxysilane, an alkylsilane, an alkyltrialkoxysilane, an aminosilane, an aminoalkylsilane, an aminopropyltrialkoxysilane, a bis-silyl-silane, an epoxysilane, a fluoroalkylsilane, a glycidyloxysilane such as, for example, a glycidyloxyalkyltrialkoxysilane, an isocyanatosilane, a mercaptosilane, a (meth)acrylatosilane, a mono-silyl-silane, a multi-silyl-silane, a bis(trialkoxysilylpropyl)amine, a bis(trialkoxysilyl)ethane, a sulfur-containing silane, a bis(trialkoxysilyl)propyltetrasulfane, a ureidosilane such as, for example, a (ureidopropyltrialkoxy)silane and/or a vinylsilane, in particular a vinyltrialkoxysilane and/or a vinyltriacetoxysilane. It can be, for example, at least one silane in a mixture with an amount of at least one alcohol such as ethanol, methanol and/or propanol of up to 8% by weight based on the silane content, preferably up to 5% by weight, more preferably up to 1% by weight, very preferably up to 0.5% by weight, where appropriate with an amount of inorganic particles, in particular in a mixture of at least one aminosilane such as, for example, bis-amino-silane with at least one alkoxysilane such as, for example, trialkoxysilylpropyltetrasulfane or a vinylsilane and a bis-silyl-aminosilane or a bis-silyl-polysulfursilane and/or a bis-silyl-aminosilane or an aminosilane and a multi-silyl-functional silane. The aqueous composition can in that case also, alternatively or additionally, contain at least one siloxane corresponding to the abovementioned silanes. Preference is given to those silanes/siloxanes which have a chain length in the range from 2 to 5 carbon atoms and contain a functional group which is suitable for reaction with polymers. The addition of at least one silane and/or siloxane may be advantageous for the purpose of developing adhesion bridges or for promoting crosslinking.

In the case of the method of the invention the inorganic compound in particle form that is added is a finely divided powder, a dispersion or a suspension, such as, for example, a carbonate, an oxide, a silicate or a sulfate, especially colloidal or amorphous particles. With particular preference the inorganic compound in particle form comprises particles based on at least one compound of aluminum, of barium, of cerium, of calcium, of lanthanum, of silicon, of titanium, of yttrium, of zinc and/or of zirconium, especially particles based on alumina, barium sulfate, cerium dioxide, rare earth mixed oxide, silica, silicate, titanium oxide, yttrium oxide, zinc oxide and/or zirconium oxide. The at least one inorganic compound is preferably in particle form in particles having an average particle size in the range from 6 nm to 0.150 nm, more preferably in the range from 7 to 120 nm, very preferably in the range from 8 to 90 nm, more preferably still in the range from 8 to 60 nm, most preferably in the range from 10 to 25 nm. It is preferred for relatively large particles to have a more platelet-shaped or elongate grain morphology.

Where inventively coated metallic substrates also provided, where appropriate, with paint or paintlike coatings are to be welded it may be advantageous to use, as particles of the compound in particle form, those with relatively high or high electrical conductivity, in particular those of oxides, phosphates, phosphides and/or sulfides of aluminum, iron or molybdenum, especially aluminum phosphide, iron oxide, iron phosphide, at least one molybdenum compound such as molybdenum sulfide, graphite and/or carbon black, it also being possible for these particles then to have an average particle size such that they protrude to a somewhat greater extent where appropriate from the layer according to the invention.

In the case of the method of the invention it is also possible to add at least one organic solvent. As organic solvent for the organic polymers it is possible to use at least one water-miscible and/or water-soluble alcohol, a glycol ether or N-methylpyrrolidone and/or water—in the case of the use of a solvent mixture, a mixture in particular of water with at least one long-chain alcohol, such as propylene glycol, an ester alcohol, a glycol ether and/or butanediol. In many cases, however, it is preferred to add only water, without any organic solvent. The amount of organic solvent is, if such is added at all, preferably from 0.1 to 10% by weight, in particular from 0.2 to 5% by weight, very preferably from 0.4 to 3% by weight. For strip production it is preferable to use only water and no organic solvent, apart possibly from small amounts of alcohol such as up to 3% by weight.

In the case of the method of the invention it is possible to add as a lubricant at least one wax selected from the group consisting of paraffins, polyethylenes, and polypropylenes, especially an oxidized wax or a HD-polyethylene. It is particularly advantageous to employ the wax as an aqueous or as a anionically or cationically stabilized dispersion, since it can then easily be held homogeneously distributed in the aqueous composition. The melting point of the wax used as lubricant is preferably in the range from 40 to 160° C., in particular in the range from 120 to 150° C. In addition to a lubricant having a melting point in the range from 120 to 165° C. it is especially advantageous to add a lubricant having a melting point in the range from 45 to 95° C. or having a glass transition temperature in the range from −20 to +60° C., particularly in amounts of from 2 to 30% by weight, preferably from 5 to 20% by weight, of the overall solids content. The last-mentioned lubricant may also be used with advantage on its own. The presence of wax is only advantageous, however, if the coating of the invention is a treatment layer, or if in a pretreatment layer the presence of wax should prove not to be deleterious for the subsequent painting operation.

The acid groups of the synthetic resin and/or of the polymer may be neutralized with ammonia, with amines such as, for example, morpholine, dimethylethanolamine, diethylethanolamine, or triethanolamine and/or with alkali metal compounds such as sodium hydroxide, for example.

The aqueous composition is preferably free from inorganic or organic acids, with the exception of hexafluoro acids where appropriate.

Furthermore, it is possible to add to the aqueous composition a basic compound, in order to keep the aqueous composition at a pH in the range from 0.5 to 5. Particularly preferred are bases selected from ammonia and amine compounds such as triethanolamine, for example.

The aqueous composition may where appropriate include in each case at least one biocide, defoamer, adhesion promoter, catalyst, corrosion inhibitor, wetting agent and/or forming additive. Certain additives have two or more functions in this context; for instance, many corrosion inhibitors are at the same time adhesion promoters and possibly also wetting agents.

The water content of the aqueous composition may vary within wide ranges. Its water content will preferably be in the range from 95 to 99.7% by weight, in particular in the range from 97.5 to 99.5% by weight, it being possible for a small part of the water content indicated here to have been replaced by at least one organic solvent. In the case of high-speed strip lines the amount of water or, where appropriate, of water together with a small amount (up to 3% by weight) of organic solvent is preferably in the range from 97 to 99% by weight, more preferably in the range from 97.5 to 98.5% by weight. If water is added to the aqueous composition, it is preferred to add fully deionized water or another somewhat purer water grade.

Metallic Substrates or Metallically Coated Substrates, Their Pretreatment, Their Coating with th Paintlike Coating, and the Further Course of the Method:

In the case of the method of the invention the pH of the aqueous solution of the organic film former without the addition of further compounds lies preferably in the range from 0.5 to 12, in particular less than 7, more preferably in the range from 1 to 6 or from 6 to 10.5, very preferably in the range from 1.5 to 4 or from 7 to 9, depending on whether the method is carried out in the acidic or rather basic range. The pH of the organic film former alone in an aqueous formulation without addition of further compounds is preferably in the range from 1 to 12.

The coating which forms may be a conversion coating or a coating containing in leached-out and incorporated form none of the elements present in the metallic surface. The coating attaches preferably to the very thin oxide/hydroxide layer sitting directly on the metallic surface or even directly to the metallic surface. Depending on whether it is desired to apply a thick or thin film, a higher or lower concentration of cations from the abovementioned group or fluoride will be required.

Particularly good coating results have been achieved with a liquid film in the range from 0.8 to 12 ml/m², in particular with a liquid film of about 2 ml/m² in a no-rinse method (drying method without subsequent rinsing step) applied with a production rollcoater or with a liquid film of about 7 ml/m² in a no-rinse method applied with a laboratory rollcoater. In the case of roller application the liquid film applied is frequently thicker (usually in the range from 2 to 10 ml/M²) than in the case of dipping and squeezing off with smooth rubber rollers (usually in the range from 1 to 6 ml/m²).

For a concentrate for making up the bath solution primarily by dilution with water or for a top-up solution for adjusting the bath solution during prolonged operation of a bath it is preferred to use aqueous compositions which comprise the majority or almost all constituents of the bath solution but not the at least one inorganic compound in particle form, which is preferably held separately and added separately. Furthermore, the addition of at least one accelerator, such as is normally employed in the case of phosphating, may also be advantageous here as well, since an accelerated attack on the metallic surface by acceleration of the oxidative dissolution of the metal and/or alloy is possible as a result. Suitable in this context are, for example, at least one peroxide and/or at least one compound based on hydroxylamine, nitroguanidine and/or nitrate. The concentrate or top-up solution preferably has a concentration which in terms of the individual constituents is from five times to ten times as greatly enriched as the bath solution.

In the case of the method of the invention the aqueous composition can be applied by roller application, flowcoating, knifecoating, squirting, spraying, brushing and/or dipping and, where appropriate, by subsequent squeezing off, for example, using a roll.

The aqueous composition may have a pH in the range from 0.5 to 12, preferably in the range from 1 to 6 or from 7 to 9, more preferably in the range from 1.5 to 4 or from 6 to 10.5, depending on whether the method is carried out in the acidic or rather in the basic range.

The aqueous composition may be applied in particular at a temperature in the range from 5 to 50° C. to the metallic surface, preferably in the range from 10 to 40° C., more preferably in the range from 18 to 25° C.

In the case of the method of the invention the metallic surface when the coating is applied may be held at temperatures in the range from 5 to 120° C., preferably in the range from 10 to 60° C., very preferably from 18 to 25° C.

In the case of films of this kind final drying may last many days, whereas the essential drying can be completed in just a few seconds. Here, the filming principally takes place during drying in the temperature range from 25 to 95° C. or, if appropriate, even at a still higher temperature. Under certain circumstances, curing may take several weeks until the ultimate state of drying and state of cure has been reached. Often in this case little if any of the polymerization will take place by thermal crosslinking or the fraction of the polymerization will be correspondingly small. The coating of the invention filmed and cured in this way can be regarded as an anticorrosion layer, in particular as treatment or pretreatment layer.

If necessary, the state of cure can additionally be accelerated or intensified by chemical and/or thermal acceleration of the crosslinking, in particular by heating and/or by actinic irradiation, for example, with UV radiation, in which case suitable synthetic resins/polymers and, where appropriate, photoinitiators are to be added. By means of corresponding additions and/or process variants it is possible to achieve a partial, substantial or complete crosslinking of the polymers. The coating of the invention crosslinked in this way can be regarded, in the case of relatively low proportions (in particular from 0.05 to 5% by weight of polymers in the aqueous composition) of polymers, as an anticorrosion layer and so used, or as a primer layer, in particular a pretreatment primer layer, when the proportions of polymer are relatively high (0.5 to 50% by weight of polymers in the aqueous composition).

Additionally, the coated metallic surface can be dried at a temperature in the range from 20 to 250° C., preferably in the range from 40 to 120° C., very preferably at from 60 to 100° C. PMT (peak metal temperature). The necessary residence time during drying is substantially inversely proportional to the drying temperature: in the case of strip-form material, for example, 1 s at 100° C. or 30 min at 20° C., while, depending among other things on their wall thickness, coated parts must be dried for significantly longer. Particularly suitable for drying is drying equipment based on air circulation, induction, infrared and/or microwaves.

The layer thickness of the coating of the invention lies preferably in the range from 0.01 to 6 μm, more preferably in the range from 0.02 to 2.5 μm, very preferably in the range from 0.03 to 1.5 μm, in particular in the range from 0.05 to 0.5 μm.

In the context of the coating of strips, the coated strips can be wound to form a coil, where appropriate after cooling to a temperature in the range from 40 to 70° C.

The coating according to the invention need not be the only treatment/pretreatment layer applied to the metallic surface; rather it may also be one treatment/pretreatment layer among two, three or even four different treatment/pretreatment layers. For example, in a system of at least two such layers, it may be applied as the second layer following, for example, an alkaline passivation such as, for example, based on Co-Fe cations. It can, for example, also be applied as the third layer in a system of at least three such layers, following for example an activating treatment based, for example, on titanium and following a pretreatment coating with, for example, a phosphate such as ZnMnNi phosphate. Furthermore, numerous additional combinations with similar or different treatment/pretreatment layers in a layer system of this kind are conceivable and highly suitable. The selection of the types and combinations of such coatings together with the coating according to the invention is above all a question of the particular application, the requirements, and the acceptable costs.

To the coating of the invention or to the topmost treatment/pretreatment layer in such a layer system it is then possible if required to apply at least one paint and/or at least one paintlike coating such as, first, a primer. To the primer coating it is possible if required to apply either a paint coat or a paintlike intermediate coat or the further coat sequence comprising, for example, surfacer and at least one topcoat. A paintlike coating is also referred to in the context of this specification as a coating of “paint”.

To the partly or fully dried and/or cured film it is possible to apply in each case at least one coating comprising paint, polymer, color, adhesives and/or adhesive backing, for example a special coating such as, for example, a coating having the property of reflecting IR radiation.

The metal parts coated inventively with the aid of the aqueous composition, especially strips or strip sections, can be formed, painted, coated with polymers such as PVC, for example, printed, coated with adhesive, hot-soldered, welded and/or joined to one another or to other elements by clinching or other joining techniques. However, the deformation usually only takes place after the painting. These processes are known per se.

The part with a metallic surface that is coated inventively with the aqueous composition may be a wire, a wire winding, a wire mesh, a steel strip, a metal sheet, a panel, a shield, a vehicle body or part of a vehicle body, a part of a vehicle, trailer, recreational vehicle or missile, a cover, a casing, a lamp, a light, a traffic light element, a furniture item or furniture element, an element of a household appliance, a frame, a profile, a molding of complex geometry, a guideboard element, radiator element or fencing element, a bumper, a part of or with at least one pipe and/or one profile, a window frame, door frame or cycle frame, or a small part such as, for example, a bolt, nut, flange, spring or a spectacle frame.

The method of the invention represents an alternative to the aforementioned chromate-containing processes, particularly in the area of the surface pretreatment of metal strip prior to painting, and in comparison with these processes provides results of similar quality in terms of corrosion control and paint adhesion.

Furthermore, it is possible to employ the method of the invention for treating the conventionally cleaned metal surface without a subsequent aftertreatment such as rinsing with water or with a suitable after-rinse solution. The method of the invention is particularly suitable for the application of the treatment solution by means of what is called a rollcoater, in which case the treatment liquid can be dried immediately following application without further downstream method steps such as, for example, rinsing steps (dry-in-place technology). As a result, the method is simplified considerably as compared, for example, with conventional spraying or dipping processes, and only very small quantities of waste water are produced after the end of operation, since hardly any bath liquid remains unused as a result of squeezing off using a roll, which also constitutes an advantage over the established chromium-free processes which operate in a spraying process with after-rinse solutions.

The coatings of the invention produce pretreatment layers which together with the subsequently applied paint produced a coating system which is equal to the best chromium-containing coating systems.

Normally the coatings according to the invention are far thinner than 0.5 μm. The thicker the coatings become, the greater the decrease in paint adhesion, although the corrosion protection is possibly somewhat improved.

The coatings of the invention are very inexpensive, environmentally friendly, and well suited to industrial use.

It was surprising that with a synthetic resin coating of the invention, despite a layer thickness of only about 0.05 or 0.2 μm μm, it was possible to produce an extremely high-quality chromium-free film which produces extraordinarily strong paint adhesion in the coating of the invention. Further, it was surprising that the addition of finely divided particles resulted in a significant improvement in paint adhesion strength; although it was possible to have hoped for an improvement in the corrosion resistance by including the inorganic particles, any improvement in the paint adhesion strength was not foreseeable.

Use of Anticorrosion Layers and/or of Paintlike or Paint Layers:

If anticorrosion layers are applied in the context of the method of the invention, this may be one to four layers, which can all be applied to one another directly, one after the other. It is preferred to apply at least two or three anticorrosion layers in succession. At least one of these layers has a composition as mentioned in the main claim. Each further one of these layers is preferably an anticorrosion layer selected from the group consisting of coatings based in each case on iron-cobalt, nickel-cobalt, at least one fluoride, at least one complex fluoride, especially tetrafluoride and/or hexafluoride, an organic hydroxy compound, a phosphate, a phosphonate, a polymer, a rare earth compound comprising at least one rare earth element, including lanthanum and yttrium, a silane/siloxane, a silicate, cations of aluminum, magnesium and/or at least one transition metal selected from the group consisting of chromium, iron, hafnium, cobalt, manganese, molybdenum, nickel, titanium, tungsten, and zirconium, or is a coating based on nanoparticles, but it is also possible where appropriate for at least one further anticorrosion layer to be applied. In this case the at least one further anticorrosion layer may be applied, as desired, before and/or after the first, second or third anticorrosion layer. It can be important to apply more than one anticorrosion layer (pretreatment layer), since the subsequent paintlike or paint layers are often kept so thin in comparison to the prior art paint systems that the corrosion control requirements must be heightened accordingly.

With the method of the invention it is possible, for example, to apply the first anticorrosion layer in a drying method and the second anticorrosion layer in a drying method or rinse method.

A drying method is a no-rinse method in which a film of liquid is applied to the optionally precoated strip. A rinse method is a method of coating which produces a coating by reaction, in particular during spraying or dipping, and in which the coating is subsequently rinsed in order to remove excess chemicals, and in which the coating, finally, is dried. It is preferred to apply coatings based, for example, on zinc phosphate and/or manganese phosphate, usually containing a small amount of nickel, by a no-rinse method. It is, however, also possible for many other kinds of coating [to be] dried together.

With this method it is possible, for example, to apply the first anticorrosion layer by a rinse method and the second anticorrosion layer by a drying method or rinse method.

In this case, the second anticorrosion layer can be applied in an afterrinsing step, in particular after the first anticorrosion layer has been applied beforehand on a galvanizing line.

The galvanizing line may preferably operate electrolytic galvanizing, electrolytic alloy galvanizing, hot galvanizing, hot-dip galvanizing and/or hot-dip alloy galvanizing. Coatings applied here may be, inter alia, pure zinc, zinc with a purity in the range from 98 to 99.9%, aluminum-zinc alloys, zinc-aluminum alloys, and zinc-nickel alloys.

The second anticorrosion layer may be applied here by a drying method, in particular after the first anticorrosion layer has been applied beforehand on a galvanizing line. Galvanizing on the galvanizing line may preferably comprise electrolytic galvanizing, hot galvanizing, hot-dip galvanizing and/or hot-dip alloy galvanizing.

With the method of the invention it is possible to coat surfaces of aluminum, iron, cobalt, copper, magnesium, nickel, titanium, tin or zinc or alloys comprising aluminum, iron, cobalt, copper, magnesium, nickel, titanium, tin and/or zinc, especially electrolytically galvanized or hot-dip galvanized surfaces. The following are preferred metallic coatings on the metallic strips: electrolytically galvanized steel, hot-dip-galvanized steel, hot-dip alloy-galvanized steel, and aluminum alloy coated with pure aluminum.

The pretreatment prior to painting is preferably chromium-free or substantially chromium-free, in particular chromium-free to the extent that no chromium is deliberately added. The pretreatment solutions also preferably contain little or no cobalt, copper, nickel and/or other heavy metals, respectively.

With the method of the invention it is possible to coat with at least one liquid, solution or suspension which is substantially or entirely free from chromium compounds before coating with at least one paint and/or with at least one paintlike polymer-containing layer which comprises polymers, copolymers, crosspolymers, oligomers, phosphonates, silanes and/or siloxanes. “Substantially free from chromium” may here mean without deliberate addition of a chromium compound. The term “liquid” also embraces solvent-free compounds or mixtures in liquid form.

This method may also be distinguished by the fact that no lead, cadmium, chromium, cobalt, copper and/or nickel is added to the liquid, solution or suspension for the first and/or second anticorrosion layer. Heavy metals which are added, such as lead, cadmium, chromium, cobalt, copper and/or nickel, are generally added only in minimal amounts.

Because of the at least one anticorrosion layer, it is possible in the case of the method of the invention, as compared with the state of the art on the priority date, to forego at least one of the otherwise customary pretreatment layers, paint layers and/or paintlike polymer-containing layers, in particular a pretreatment layer and a paint layer (see Tables 2A-J relating to variants A ff).

In this case the liquid, solution or suspension for at least one of the anticorrosion layers and/or paintlike polymer-containing layers may comprise, in addition to water, at least one organic film former with at least one water-soluble or water-dispersed polymer, copolymer, block copolymer, crosspolymer, monomer, oligomer, derivative(s) thereof, mixture(s) thereof and/or addition copolymer(s) thereof. The fraction of these organic compounds in a layer is preferably in the range from 60 to 99.8% by weight, based on the solids content.

In this context, the liquid, solution or suspension for at least one of the anticorrosion layers and/or paintlike polymer-containing layers may comprise, in addition to water, a total content of cations, tetrafluoro complexes and/or hexafluoro complexes of cations selected from the group consisting of titanium, zirconium, hafnium, silicon, aluminum, and boron and/or free or otherwise-bound fluorine, in particular from 0.1 to 15 g/L complex fluoride based on F₆, preferably from 0.5 to 8 g/L complex fluoride based on F₆, or from 0.1 to 1 000 mg/L free fluorine. The fraction of these compounds in a layer is preferably in the range from 5 to 99.9% by weight.

In this context, the liquid, solution and/or suspension for at least one of the anticorrosion layers and/or paintlike polymer-containing layers may comprise, in addition to water, a total content of free fluorine or fluorine not attached to tetrafluoro or hexafluoro complexes, in particular from 0.1 to 1 000 mg/L calculated as free fluorine, preferably from 0.5 to 200 mg/L, more preferably from 1 to 150 mg/L.

In the case of the method of the invention the liquid, solution or suspension for at least one of the anticorrosion layers, paint layers and/or paintlike polymer-containing layers may comprise, in addition to water, at least one inorganic compound in particle form having an average particle diameter, measured under a scanning electron microscope, in the range from 0.003 up to 1 μm diameter, preferably in the range from 0.005 up to 0.2 μm diameter, based in particular on Al₂O₃, BaSO₄, rare earth oxide(s), at least one other rare earth compound, SiO₂, silicate, TiO₂, Y₂O₃, Zn, ZnO and/or ZrO₂, preferably in an amount in the range from 0.1 to 80 g/L, more preferably in an amount in the range from 1 to 50 g/L, very preferably in an amount in the range from 2 to 30 g/L. The fraction of these compounds in particle form in a layer is preferably in the range from 5 to 90% by weight, more preferably in the range from 10 to 50% by weight. Electrically conductive particles can be used as well, such as iron oxide, iron phosphide, molybdenum compounds such as molybdenum sulfide, graphite and/or carbon black, for example, and/or it is also possible to use an addition of conductive polymers if the metal sheets are to be joined, where appropriate by welding. These anticorrosion layers are preferably free of elemental zinc.

In the case of the method of the invention the liquid, solution or suspension for at least one of the anticorrosion layers, paint layers or paintlike polymer-containing layers may comprise at least one corrosion inhibitor. The corrosion inhibitor may contain at least one organic group and/or at least one amino group. It can be an organic compound or an ammonium compound, in particular an amine or an amino compound, such as, for example, an alkanolamine, a TPA-amine complex, a phosphonate, a polyaspartic acid, a thiourea, a Zr ammonium carbonate, benzotriazole, a tannin, an electrically conductive polymer such as a polyaniline, for example, and/or contain derivatives thereof. In particular it is selected from the group consisting of organic phosphate compounds, phosphonate compounds, organic morpholine and thio compounds, aluminates, manganates, titanates, and zirconates, preferably of alkylmorpholine complexes, organic Al, Mn, Ti and/or Zr compounds especially of the olefinically unsaturated carboxylic acids, for example, ammonium salt of carboxylic acids such as chelated lactic acid titanate, triethanolamine titanate or triethanolamine zirconate, Zr-4-methyl-γ-oxo-benzyne-butanoic acid, aluminum zirconium carboxylate, alkoxypropenolatotitanate or alkoxypropenolatozirconate, titanium acetate and/or zirconium acetate and/or derivatives thereof, Ti/Zr ammonium carbonate. The fraction of these compounds in a layer is preferably in the range from 5 to 40% by weight.

In this context, the liquid, solution or suspension for at least one of the anticorrosion layers, paint layers or paintlike polymer-containing layers may comprise at least one compound for the neutralization, in particular the slow neutralization, of comparatively acidic mixtures and/or for the corrosion control of unprotected or damaged portions of the metallic surface, based preferably on carbonate or hydroxycarbonate or conductive polymers, more preferably at least one basic compound with a layer structure such as, for example, Al-containing hydroxy-carbonate hydrate (hydrotalcite). The fraction of these compounds in a layer is preferably in the range from 3 to 30% by weight.

In this context, the liquid, solution or suspension for at least one of the anticorrosion layers, paint layers and/or paintlike polymer-containing layers may in addition to water comprise at least one silane and/or siloxane, calculated as silane, in particular in an amount in the range from 0.1 to 50 g/L, preferably in an amount in the range from 1 to 30 g/L.

In this context, the liquid, solution or suspension for at least one of the anticorrosion layers, paint layers and/or paintlike polymer-containing layers may in addition to water and/or at least one organic solvent comprise at least one silane and/or siloxane, calculated as silane, in particular in an amount in the range from 51 to 1 300 g/L.

In this context, the liquid, solution or suspension for at least one of the anticorrosion layers, paint layers and/or paintlike polymer-containing layers may where appropriate in addition to water and/or at least one organic solvent comprise at least one silane and/or siloxane, calculated as silane, in particular in an amount in the range from 0.1 to 1 600 g/L, preferably in an amount in the range from 100 to 1 500 g/L.

The silane may be an acyloxysilane, an alkylsilane, an alkyltrialkoxysilane, an aminosilane, an aminoalkylsilane, an aminopropyltrialkoxysilane, a bis-silyl-silane, an epoxysilane, a fluoroalkylsilane, a glycidyloxysilane such as, for example, a glycidyloxytrialkoxysilane, an isocyanatosilane, a mercaptosilane, a (meth)acrylatosilane, a mono-silyl-silane, a multi-silyl-silane, a bis(trialkoxysilylpropyl)amine, a bis(trialkoxysilyl)ethane, a sulfur-containing silane, a bis(trialkoxysilyl)propyltetrasulfane, a ureidosilane such as, for example, a (ureidopropyltrialkoxy)silane and/or a vinylsilane, in particular a vinyltrialkoxysilane and/or a vinyltriacetoxysilane. It can be, for example, at least one silane in a mixture with up to 8% by weight, based on the silane content, of at least one alcohol such as ethanol, methanol and/or propanol, preferably up to 5% by weight, more preferably up to 1% by weight, very preferably up to 0.5% by weight, in the presence or absence of inorganic particles, in particular in a mixture of at least one aminosilane such as, for example, bis-amino-silane with at least one alkoxysilane such as, for example, trialkoxysilylpropyltetrasulfane or a vinylsilane and a bis-silyl-aminosilane or a bis-silyl-polysulfur-silane and/or a bis-silyl-aminosilane or an amino silane and a multi-silyl-functional silane.

In the case of the method of the invention the liquid, solution or suspension for at least one of the anticorrosion layers, paint layers and/or paintlike polymer-containing layers may comprise an organic film former in the form of a solution, dispersion, emulsion, microemulsion and/or suspension.

In this context, the liquid, solution or suspension for at least one of the anticorrosion layers, paint layers and/or paintlike polymer-containing layers may comprise as organic film former at least one synthetic resin, in particular at least one synthetic resin based on acrylate, ethylene, polyester, polyurethane, silicone-polyester, epoxide, phenol, styrene, styrene-butadiene, urea-formaldehyde, their derivatives, copolymers, block copolymers, crosspolymers, monomers, oligomers, polymers, mixtures and/or addition copolymers. As a generic term for all of these variants of synthetic resins and their derivatives, copolymers, block copolymers, crosspolymers, monomers, oligomers, polymers, mixtures, and addition copolymers, the term “polymer” is used here, in particular for the paintlike layers as well.

In this context, the liquid, solution or suspension for at least one of the anticorrosion layers, paint layers and/or paintlike polymer-containing layers may comprise as organic film former a synthetic resin mixture and/or addition copolymer comprising synthetic resin based on acrylate, ethylene, urea-formaldehyde, polyester, polyurethane, styrene and/or styrene-butadiene and/or their derivatives, copolymers, crosspolymers, oligomers, polymers, mixtures and/or addition copolymers, from which an organic film is formed during or after the emission of water and other volatile constituents.

In this context, the liquid, solution or suspension for at least one of the anticorrosion layers, paint layers and/or paintlike polymer-containing layers may comprise as organic film former synthetic resins and/or polymers, copolymers, block copolymers, crosspolymers, monomers, oligomers, polymers, mixtures and/or addition copolymers and/or their derivatives based on acrylate, polyethyleneimine, polyurethane, polyvinyl alcohol, polyvinylphenol, polyvinylpyrrolidone and/or polyaspartic acid, especially copolymers with a phosphorus-containing vinyl compound.

In this context, the liquid, solution or suspension for at least one of the anticorrosion layers, paint layers and/or paintlike polymer-containing layers may comprise a synthetic resin whose acid number is in the range from 5 to 250. The acid number is preferably in the range from 10 to 140, more preferably in the range from 15 to 100.

In this context, the liquid, solution or suspension for at least one of the anticorrosion layers, paint layers and/or paintlike polymer-containing layers may comprise synthetic resins and/or polymers, copolymers, block copolymers, crosspolymers, monomers, oligomers, polymers, mixtures and/or addition copolymers and/or derivatives thereof whose molecular weights are in the range of at least 1 000 u, preferably of at least 5 000 u or of up to 500 000 u, more preferably in the range from 20 000 to 200 000 u.

In this context, the liquid, solution or suspension for at least one of the anticorrosion layers, paint layers and/or paintlike polymer-containing layers may comprise synthetic resins and/or polymers, block copolymers, copolymers, crosspolymers, monomers, oligomers, polymers, mixtures and/or addition copolymers and/or derivatives thereof, in particular based inter alia on pyrrolidone(s), in particular from 0.1 to 500 g/L, preferably from 0.5 to 30 or from 80 to 250 g/L.

In this context, the liquid, solution or suspension for at least one of the anticorrosion layers, paint layers and/or paintlike polymer-containing layers may comprise an organic film former whose pH in an aqueous formulation without addition of further compounds is in the range from 1 to 12, preferably in the range from 2 to 10, more preferably in the range from 2.5 to 9.

In this context, the liquid, solution or suspension for at least one of the anticorrosion layers, paint layers and/or paintlike polymer-containing layers may comprise an organic film former which contains only water-soluble synthetic resins and/or polymers, copolymers, block copolymers, crosspolymers, monomers, oligomers, polymers, mixtures and/or addition copolymers and/or their derivatives, particularly those which are stable in solutions with pH levels <5.

In this context, the liquid, solution or suspension for at least one of the anticorrosion layers, paint layers and/or paintlike polymer-containing layers may comprise an organic film former whose synthetic resins and/or polymers, copolymers, block copolymers, crosspolymers, monomers, oligomers, polymers, mixtures and/or addition copolymers and/or their derivatives contain carboxyl groups.

In this context, the liquid, solution or suspension for at least one of the anticorrosion layers, paint layers and/or paintlike polymer-containing layers may comprise an organic film former in which the acid groups of the synthetic resins and/or polymers, copolymers, block copolymers, crosspolymers, monomers, oligomers, polymers, mixtures and/or addition copolymers and/or their derivatives have been stabilized with ammonia, with amines such as morpholine, dimethylethanolamine, diethylethanolamine or triethanolamine, for example, and/or with alkali metal compounds such as sodium hydroxide, for example.

In the case of the method of the invention the liquid, solution or suspension for at least one of the anticorrosion layers, paint layers and/or paintlike polymer-containing layers comprise from 0.1 to 200 g/L and preferably from 0.3 to 50 g/L of the organic film former, in particular from 0.6 to 20 g/L.

In this context, the liquid, solution or suspension for at least one of the anticorrosion layers, paint layers and/or paintlike polymer-containing layers can comprise from 100 to 2 000 g/L and preferably from 300 to 1 800 g/L of the organic film former, in particular from 800 to 1 400 g/L.

In the case of the method of the invention the liquid, solution or suspension for at least one of the anticorrosion layers, paint layers and/or paintlike polymer-containing layers may include a monomer fraction, in particular in the region of at least 5% by weight, preferably of at least 20% by weight, more preferably of at least 40% by weight. In this context, especially with a high fraction of monomers, it is possible, where appropriate, for the fraction of water and/or organic solvent to be reduced and in particular to be less than 10% by weight; in certain circumstances it may even be entirely or substantially free from water and/or organic solvent.

In the case of the method of the invention the liquid, solution or suspension for at least one of the anticorrosion layers, paint layers and/or paintlike polymer-containing layers may comprise from 0.1 to 50 g/L of cations, tetrafluoro complexes and/or hexafluoro complexes of cations selected from the group consisting of titanium, zirconium, hafnium, silicon, aluminum, and boron, preferably hexafluoro complexes of titanium, zirconium and/or silicon preferably a coating of 2 to 20 g/L.

In this context, the liquid, solution or suspension for at least one of the anticorrosion layers, paint layers and/or paintlike polymer-containing layers may comprise at least one organometallic compound, particularly containing titanium and/or zirconium. These organometallic compounds are often corrosion inhibitors and often also adhesion promoters at the same time.

In the case of the method of the invention the liquid, solution or suspension for at least one of the anticorrosion layers, paint layers and/or paintlike polymer-containing layers may include at least one silane and/or siloxane calculated as silane in the aqueous composition, preferably in a range from 0.2 to 40 g/L, more preferably in a range from 0.5 to 10 g/L.

In this context, the liquid, solution or suspension for at least one of the anticorrosion layers, paint layers and/or paintlike polymer-containing layers may comprise at least one partly hydrolyzed silane, at least one wholly hydrolyzed silane and/or at least one siloxane. In the course of the curing of the coating, siloxanes are formed from the silanes. It is also possible, however, to add corresponding siloxanes. The silanes/siloxanes may be used either alone, in a mixture, for example, with at least one fluoride complex, or else together with polymers.

In this context, the liquid, solution or suspension for at least one of the anticorrosion layers, paint layers and/or paintlike polymer-containing layers may comprise at least one partly hydrolyzed and/or nonhydrolyzed silane, in particular in the case of a silane content of more than 100 g/L, more preferably in the case of a silane content of more than 1 000 g/L.

In this context, the liquid, solution or suspension for at least one of the anticorrosion layers, paint layers and/or paintlike polymer-containing layers may comprise in each case at least one acyloxysilane, alkylsilane, aminosilane, bis-silyl-silane, epoxysilane, fluoroalkylsilane, glycidyloxysilane, isocyanatosilane, mercaptosilane, (meth)acrylatosilane, mono-silyl-silane, multi-silyl-silane, sulfur-containing silane, ureidosilane, vinylsilane and/or at least one corresponding siloxane.

In the case of the method of the invention the liquid, solution or suspension for at least one of the anticorrosion layers, paint layers and/or paintlike polymer-containing layers may have added to it as inorganic compound in particle form a finely divided powder, a dispersion or a suspension such as, for example, a carbonate, oxide, silicate or sulfate, especially colloidal or amorphous particles.

In this context it is possible for the liquid, solution or suspension for at least one of the anticorrosion layers, paint layers and/or paintlike polymer-containing layers to have added to it as inorganic compound in particle form particles having an average size in the range from 4 nm to 150 nm, in particular in the range from 10 to 120 nm. The average size of the electrically conducting particles of a welding primer may be situated within the range from 0.02 to 15 μm.

In this context, the liquid, solution or suspension for at least one of the anticorrosion layers, paint layers and/or paintlike polymer-containing layers may have added to it as inorganic compound in particle form particles based on at least one compound of aluminum, barium, cerium, calcium, lanthanum, silicon, titanium, yttrium, zinc and/or zirconium.

In this context, to the liquid, solution or suspension for at least one of the anticorrosion layers, paint layers and/or paintlike polymer-containing layers may comprise from 0.1 to 300 g/L, preferably from 0.2 to 60 g/L, of the at least one inorganic compound in particle form.

In the case of the method of the invention the liquid, solution or suspension for at least one of the anticorrosion layers, paint layers and/or paintlike polymer-containing layers may as organic solvent for the organic polymers be used at least one water-miscible and/or water-soluble alcohol, one glycol ether and/or one pyrrolidone such as, for example, N-methylpyrrolidone, and/or water; where a solvent mixture is used, it is in particular a mixture of at least one long-chain alcohol, such as propylene glycol, for example, an ester alcohol, a glycol ether and/or butanediol with water, but preferably only water without organic solvent.

In the case of the method of the invention the liquid, solution or suspension for at least one of the anticorrosion layers, paint layers and/or paintlike polymer-containing layers may comprise organic solvent in an amount in the range from 0.1 to 10% by weight.

In the case of the method of the invention the liquid, solution or suspension for at least one of the anticorrosion layers, paint layers and/or paintlike polymer-containing layers may comprise as lubricant at least one wax selected from the group consisting of paraffins, polyethylenes, and polypropylenes, in particular an oxidized wax. The amount of waxes in a layer is preferably in the range from 0.1 to 20% by weight.

In this context, the liquid, solution or suspension for at least one of the anticorrosion layers, paint layers and/or paintlike polymer-containing layers may comprise a wax lubricant whose melting point is in the range from 40 to 160° C., preferably from 0.1 to 100 g/L, more preferably from 20 to 40 g/L or from 0.1 to 10 g/L, very preferably 0.4 to 6 g/L, for example, a crystalline polyethylene wax.

In the case of the method of the invention the liquid, solution or suspension for at least one of the anticorrosion layers, paint layers and/or paintlike polymer-containing layers may comprise at least one rare earth element compound, in particular at least one compound selected from the group consisting of chloride, nitrate, sulfate, sulfamate, and complexes, for example, with a halogen or with an aminocarboxylic acid, in particular complexes with EDTA, NTA or HEDTA, in which context scandium, yttrium, and lanthanum are also regarded as being rare earth elements.

In this context, the liquid, solution or suspension for at least one of the anticorrosion layers and/or paintlike polymer-containing layers may comprise a rare earth element compound of and/or with cerium, in particular in a mixture with other rare earth elements, for example, at least partly based on mixed metal. The amount of cerium compounds in a layer is preferably in the range from 0.1 to 99% by weight, more preferably in the range from 25 to 95% by weight. The at least one rare earth element compound is used in the aqueous solution preferably in an amount of from 1 to 80 g/L together with an amount in the region of at least 10 mg/L of chloride, with an amount of peroxide in the range from 1 to 50 g/L, calculated as H₂O₂, and with an amount of at least one cation selected from main group 5 or 6 of the periodic table of the elements, in particular of bismuth ions, in the range from 0.001 to 1 g/L. The amount of the at least one rare earth element compound in the aqueous solution is preferably from 5 to 25 g/L together with an amount in the region of not more than 500 mg/L of chloride, with an amount of peroxide in the range from 5 to 25 g/L, calculated as H₂O₂, and with an amount of at least one cation selected from main group 5 or 6 of the periodic table of the elements, in particular of bismuth ions, in the range from 0.01 to 0.3 g/L.

In the case of the method of the invention the liquid, solution or suspension for at least one of the anticorrosion layers, paint layers and/or paintlike polymer-containing layers may comprise at least one oxidizing agent, in particular a peroxide, at least one accelerator and/or at least one catalyst, preferably a compound and/or ions of Bi, Cu and/or Zn.

In the case of the method of the invention the liquid, solution or suspension for at least one of the anticorrosion layers, paint layers and/or paintlike polymer-containing layers may comprise at least one compound selected from the group of the mono-, bis-, and multi-silanes, especially:

mono-silanes of the general formula SiXₘY₄₋ₘ

with m=1 to 3, preferably m=2 to 3,

with X=alkoxy, especially methoxy, ethoxy and/or propoxy, and

with Y as a functional organic group selected from the group consisting of acyloxy, alkyl, acrylate, amino, epoxy, fluoroalkyl, glycidyloxy, urea, isocyanate, mercapto, methacrylate and/or vinyl and/or derivatives thereof,

bis-silanes of the general formula Y₃₋ₚXₚ—Si-Z-Si—XₙY₃₋ₙ

with p and n=1 to 3, identical or different,

with X=alkoxy, especially methoxy, ethoxy and/or propoxy, and

with Y as a functional organic group selected from the group consisting of acyloxy, alkyl, acrylate, amino, epoxy, fluoroalkyl, glycidyloxy, urea, isocyanate, mercapto, methacrylate and/or vinyl and/or derivatives thereof,

with Z selected from the group of CₙH₂ₙ with n=2 to 20, in each case branched or unbranched, of singly unsaturated alkyl chains of the general formula CₙH₂ₙ₋₂ with n=2 to 20, in each case branched or unbranched, of doubly and/or multiply unsaturated alkyl compounds of the general formulae CₙH₂ₙ₋₄ with n=4 to 20, in each case branched or unbranched, CₙH₂ₙ₋₆ with n=6 to 20, in each case branched or unbranched, or CₙH₂ₙ₋₈ with n=8 to 20, in each case branched or unbranched, of ketones, monoalkylamines, NH, and sulfur S_{q} with q=1 to 20,

multi-silanes of the general formula Y₃₋ₚXₚ—Si-Z′-Si—XₙY₃₋ₙ

with p and n=1 to 3, identical or different,

with X=alkoxy, especially methoxy, ethoxy and/or propoxy, and

with Y as a functional organic group selected from the group consisting of acyloxy, alkyl, acrylate, amino, epoxy, fluoroalkyl, glycidyloxy, urea, isocyanate, mercapto, methacrylate, mono/bis/multi-silyl and vinyl and/or derivatives thereof,

and with Z′=N—Si—XᵣY₃₋ᵣ with r=1 to 3 or sulfur S_{q} with q=1 to 20,

multi-silanes of the general formula Y₃₋ₚXₚ—Si-Z″-Si—X_{N}Y₃₋ₙ with p and n=1 to 3, identical or different,

with X=alkoxy, especially methoxy, ethoxy and/or propoxy, and

with Y as a functional organic group selected from the group consisting of acyloxy, alkyl, acrylate, amino, epoxy, fluoroalkyl, glycidyloxy, urea, isocyanate, mercapto, methacrylate, mono/bis/multi-silyl and vinyl and/or derivatives thereof,

and with Z″=—R—C[(SiXₛY_{3-S})(SiXₜY₃₋ₜ)]—R′— or sulfur S_{q} with q=1 to 20,

with s and t=1 to 3, identical or different, with R and R′, identical or different, selected from the group of C_{N}H_{2-N} with n=2 to 20, in each case branched or unbranched, of singly unsaturated alkyl chains of the general formula C_{N}H₂ₙ₋₂ with n=2 to 20, in each case branched or unbranched, of doubly and/or multiply unsaturated alkyl compounds of the general formulae C_{N}H₂ₙ₋₄ with n=4 to 20, in each case branched or unbranched, CₙH₂ₙ₋₆ with n=6 to 20, in each case branched or unbranched, or CₙH₂ₙ₋₈ with n=8 to 20, in each case branched or unbranched, of ketones, monoalkylamines, and NH,

it being possible for the silanes in each case to be present in hydrolyzed, partly hydrolyzed and/or nonhydrolyzed form in a solution, emulsion and/or suspension.

In this context, the total amount of silanes and/or siloxanes per layer can be preferably, on the one hand, in the range from 0.01 to 20% by weight, on the other hand, preferably, in the range from 60 to 99.9% by weight.

In the case of the method of the invention the liquid, solution or suspension for at least one of the anticorrosion layers may comprise at least one compound of the type XYZ, X*Y*Z* and/or X*Y*Z*Y*X*,

where Y is an organic group having 2 to 50 carbon atoms,

where X and Z, identical or different, are an OH, SH, NH₂, NHR′, CN, CH═CH₂, OCN, CONHOH, COOR′, acrylamide, epoxide, CH₂═CR″—COO, COOH, HSO₃, HSO₄, (OH)₂PO, (OH)₂PO₂, (OH)(OR′)PO, (OH)(OR′)PO₂, SiH₃ and/or an Si(OH)₃ group,

where R′ is an alkyl group having 1 to 4 carbon atoms,

where R″ is a hydrogen atom or an alkyl group having 1 to 4 carbon atoms, where the groups X and Z are each attached to the group Y in the terminal position thereof,

where Y* is an organic group having 1 to 30 carbon atoms,

where X* and Z*, identical or different, are an OH, SH, NH₂, NHR′, CN, CH═CH₂, OCN, CONHOH, COOR′, acrylamide, epoxide, CH₂═CR*—COO, COOH, HSO₃, HSO₄, (OH)₂PO, (OH)₂PO₂, (OH)(OR′)PO, (OH)(OR′)PO₂, SiH₃, Si(OH)₃, >N—CH₂—PO(OH)₂ and/or an —N-[CH₂—PO(OH)₂]₂ group,

where R′ is an alkyl group having 1 to 4 carbon atoms, and

where R″ is a hydrogen atom or an alkyl group having 1 to 4 carbon atoms.

In this context, the liquid, solution or suspension for at least one of the anticorrosion layers may comprise at least one compound of the type XYZ, where X is a COOH, HSO₃, HSO₄, (OH)₂PO, (OH)₂PO₂, (OH)(OR′)PO or (OH)(OR′)PO₂ group,

where Y is an organic group R containing 2 to 50 carbon atoms, of which at least 60% of these carbon atoms are present in the form of CH₂ groups,

where Z is an OH, SH, NH₂, NHR′, CN, CH═CH₂, OCN, epoxy, CH═CR″—COOH, acrylamide, COOH, (OH)₂PO, (OH)₂PO₂, (OH) (OR′)PO or (OH) (OR′)PO₂ group,

where R′ is an alkyl group having 1 to 4 carbon atoms,

and where R″ is a hydrogen atom or an alkyl group having 1 to 4 carbon atoms, preferably in total from 0.01 to 10 g/L, preferably from 0.05 to 5 g/L, very preferably from 0.08 to 2 g/L.

In this context, the compound of type XYZ, X*Y*Z* and/or X*Y*Z*Y*X* may be suitable for forming self-arranging molecules, which may shape a layer of these self-arranging molecules particularly on the metallic surface, preferably a monomolecular layer.

In this context, the liquid, solution or suspension for at least one of the anticorrosion layers may comprise at least one of the following compounds of type XYZ, X*Y*Z* and/or X*Y*Z*Y*X*:

1-phosphonic acid-12-mercaptododecane,

1-phosphonic acid-12-(N-ethylamino)dodecane,

1-phosphonic acid-12-dodecene,

p-xylylenediphosphonic acid,

1,10-decanediphosphonic acid,

1,12-dodecanediphosphonic acid,

1,14-tetradecanediphosphonic acid,

1-phosphoric acid-12-hydroxydodecane,

1-phosphoric acid-12-(N-ethylamino)dodecane,

1-phosphoric acid-12-dodecene,

1-phosphoric acid-12-mercaptododecane,

1,10-decanediphosphoric acid,

1,12-dodecanephosphoric acid,

1,14-tetradecanediphosphoric acid,

p,p′-biphenyldiphosphoric acid,

1-phosphoric acid-12-acryloyldodecane,

1,8-octanediphosphonic acid,

1,6-hexanediphosphonic acid,

1,4-butanediphosphonic acid,

1,8-octanediphosphoric acid,

1,6-hexanediphosphoric acid,

1,4-butanediphosphoric acid,

aminotrimethylenephosphonic acid,

ethylenediaminetetramethylenephosphonic acid,

hexamethylenediaminetetramethylenephosphonic acid,

diethylenetriaminepentamethylenephosphonic acid,

2-phosphonobutane-1,2,4-tricarboxylic acid.

The amounts of compounds of these types in a layer is preferably in the range from 50 to 100% by weight.

In the case of the method of the invention at least one of the liquids, solutions or suspensions for at least one of the anticorrosion layers and/or paintlike polymer-containing layers may comprise phosphate and zinc, where appropriate also manganese, nickel and/or copper. The amount of phosphates in a layer is preferably in the range from 8 to 100% by weight, more preferably in the range from 20 to 95% by weight, very preferably in the range from 60 to 90% by weight.

In the case of the method of the invention at least one of the liquids, solutions or suspensions for at least one of the anticorrosion layers and/or paintlike polymer-containing layers may contain from 0.1 to less than 100 g/L zinc ions, from 0.4 to 80 g/L manganese ions, up to 12 g/L nickel ions, up to 100 g/L peroxide, calculated as H₂O₂, and from 1 to 500 g/L phosphate ions, calculated as P₂O₅, and also, preferably, from 0.2 to less than 50 g/L zinc ions, from 0.5 to 45 g/L manganese ions, and from 2 to 300 g/L phosphate ions, calculated as P₂O₅.

In the case of the method of the invention at least one of the liquids, solutions or suspensions for at least one of the anticorrosion layers and/or paintlike polymer-containing layers may comprise phosphate, preferably based on Zn or ZnMn, where appropriate with nickel content.

In the case of the method of the invention at least one of the liquids, solutions or suspensions for at least one of the anticorrosion layers, paint layers and/or paintlike polymer-containing layers may comprise phosphate, fluoride, tetrafluoride and/or hexafluoride. Preferably, however, phosphonate(s), which align themselves at least partially as self-arranging molecules on the metallic surface, and fluoride complexes with separate solutions in largely separate layers are formed.

In the case of the method of the invention at least one of the liquids, solutions or suspensions for at least one of the anticorrosion layers, paint layers and/or paintlike polymer-containing layers may comprise phosphonate, tetrafluoride and/or hexafluoride.

In the case of the method of the invention at least one of the liquids, solutions or suspensions for at least one of the anticorrosion layers, paint layers and/or paintlike polymer-containing layers may comprise an organic film former, fluoride, tetrafluoride, hexafluoride and/or at least one inorganic compound in particle form, and, where appropriate, at least one silane.

In the case of the method of the invention at least one of the liquids, solutions or suspensions for at least one of the anticorrosion layers, paint layers and/or paintlike polymer-containing layers may comprise an additive selected from the group consisting of organic binders, biocides, defoamers, corrosion inhibitors, adhesion promoters, wetting agents, photoinitiators, and polymerization inhibitors.

In the case of the method of the invention at least one of the liquids, solutions or suspensions for at least one of the anticorrosion layers, paint layers and/or paintlike polymer-containing layers may comprise at least one filler and/or one pigment, in particular at least one electrically conductive pigment selected from the group consisting of dyes, color pigments, graphite, graphite-mica pigments, oxides such as iron oxides, molybdenum compounds, phosphates, phosphides such as iron phosphides, carbon black and zinc. The amount of such compounds in a layer is preferably in the range of from 0.1 to 60% by weight, more preferably in the range from 5 to 35% by weight.

In the case of the method of the invention an activating treatment can be applied prior to the application of an anticorrosion layer, paint layer and/or paintlike polymer-containing layer, preferably an activation based on titanium.

In the case of the method of the invention the application of an anticorrosion layer, paint layer or paintlike polymer-containing layer may be followed by application of an afterrinse and/or passivation, preferably an after-rinse solution based on rare earth compounds, complex fluorides, silanes, titanium compounds and/or zirconium compounds and/or a passivating solution based on rare earth compounds, complex fluorides, silanes, titanium compounds and/or zirconium compounds.

In the case of the method of the invention at least one of the liquids, solutions or suspensions for at least one of the anticorrosion layers, paint layers and/or paintlike polymer-containing layers may comprise an organic film former which, following application to the metallic substrate, is cured by heat and/or actinic radiation, in particular by electrons, UV and/or radiation in the visible light region.

In the case of the method of the invention at least one of the anticorrosion layers, paint layers and/or paintlike polymer-containing layers may be only partly cured prior to adhesive bonding, welding, and/or forming and not fully cured until after adhesive bonding, welding and/or forming, the first curing before adhesive bonding, welding and/or forming taking place by actinic radiation—in particular by electrons, UV and/or radiation in the visible light region—and the second curing taking place after adhesive bonding, welding and/or forming, preferably thermally, in particular by radiant heat and/or hot air. The first cure takes place preferably nonthermally, in particular by UV radiation, since there are normally no ovens for heating present in the metal strip line, in particular in the strip galvanizing line. The second cure preferably takes place thermally, especially when the metal sheet is to be aftercured at the same time. The second cure, however, takes place preferably by means of actinic radiation, in particular by UV radiation, since this is often accompanied by better through-curing than by means of thermal crosslinking alone. Furthermore, it is also possible to utilize more than one type of cure in each of the curing steps. For the sake of simplicity, actinic radiation is referred to in this specification as UV radiation and the associated cure is termed UV curing.

In the case of the method of the invention, the liquid, solution or suspension for at least one of the anticorrosion layers, paint layers and/or paintlike polymer-containing layers may have a pH in the range from 0.5 to 12, preferably in the range from to 1 to 11, more preferably in the range from 2 to 10.

In the case of the method of the invention, the liquid, solution or suspension for at least one of the anticorrosion layers, paint layers and/or paintlike polymer-containing layers may be applied to the respective surface at a temperature in the range from 5 to 95° C., preferably in the range from 5 to 50° C., very preferably in the range from 10 to 40° C.

In this context, the substrate and/or the respective surface may be held during application of the anticorrosion layer(s) at temperatures in the range from 5 to 120° C. In the case of the first coating this may be the metallic surface. The first or second anticorrosion layer or basecoat may be applied preferably in a temperature range from 10 to 50° C.

The coated metallic surface may in this case be dried at a temperature in the range from 20 to 400° C. PMT (peak metal temperature). The first and second anticorrosion layer may be applied preferably in a temperature range of 15 to 100° C., the basecoat in particular in a temperature range from 15 to 270° C.

In the case of the method of the invention the coated strips may be cut up or wound to a coil, where appropriate after cooling to a temperature in the range from 10 to 70° C.

Method of one of the above claims, characterized in that the divided strips, after pressing, cutting and/or punching, are coated in the edge region with a temporarily applied coating to be removed again or with a permanently protecting coating, e.g., at least one coating based on dry lubricant, phosphate, hexafluoride, paintlike coating and/or paint.

In the case of the method of the invention the liquid, solution or suspension for at least one of the anticorrosion layers, paint layers and/or paintlike polymer-containing layers can be applied by rolling, flowcoating, knifecoating, spraying, squirting, brushing or dipping and, where appropriate, by subsequent squeezing off with a roll.

In the case of the method of the invention the coating applied in each case with the liquid, solution or suspension for at least one of the anticorrosion layers, paint layers and/or paintlike polymer-containing layers can be adjusted to a layer weight in the range from 0.0005 mg/m² to 150 g/m², preferably in the range from 0.0008 mg/m² to 30 g/m², more preferably in the range from 0.001 mg/m² to 10 g/m², in particular in the range from 1 to 6 g/m².

In the case of the method of the invention at least one coating of paint or of a paintlike, polymer-containing coating can be applied in each case to the partly or fully cured film, the first paint layer or paintlike polymer-containing layer being able to be composed essentially of primer, a thinly—in the range from 0.1 to 10 μm, preferably in the range from 0.15 to 6 μm, more preferably in the range from 0.2 to 4 μm—organically applied, polymer-containing material (called a permanent coating), a reaction primer, a shop primer or a wash primer. For the purposes of this specification a reaction primer is a primer such as, for example, a coil coating primer, a primer as replacement for the cathodic dip coat, or a welding primer.

In the case of the method of the invention it is possible to apply in each case at least one coating of paint, a mixture of or with polymers, varnish, adhesive and/or adhesive backing to the at least partly painted strip or the strip at least partly coated in a paintlike manner with a polymer-containing layer, or to the at least partly painted strip section or the strip section coated at least partly in a paintlike manner with a polymer-containing layer.

In the case of the method of the invention the clean or cleaned and, where appropriate, activated metallic surface may be contacted with the liquid, solution or suspension for one of the anticorrosion layers, and at least one film, which where appropriate may also contain particles, may be formed on the metallic surface, which is subsequently dried and, where appropriate, additionally cured, the dried and, where appropriate, also cured film possibly having in each case a thickness in the range from 0.01 to 100 μm, in particular a film with a thickness in the range from 5 up to 50 μm, more preferably in the range from 8 up to 30 μm. Particles which can be used include pigments, especially color pigments or white pigments, metal particles such as zinc particles, fillers of all kinds such as, for example, chalk, oxides such as alumina, talc or silicates, carbon particles, and nanoparticles.

In this context at least one paint layer may be applied as undercoat or one paintlike polymer-containing layer as pretreatment primer, primer, primer as replacement of the cathodic dip coat, lubricating primer, reaction primer, welding primer and/or wash primer, where appropriate instead of an undercoat. The overall paint system may in certain circumstances amount to up to 300 μm, generally up to 120 μm, often up to 90 μm, occasionally up to only 70 μm, if using more than one paint and/or paintlike layer.

In this context, at least one of the paint layers and/or paintlike polymer-containing layers may be cured by heat and/or actinic radiation, in particular by UV radiation.

In the case of the method of the invention the coated strips or strip sections may be subjected to forming, painted, coated with polymers such as PVC, for example, printed, bonded, hot soldered, welded and/or joined with one another or with other elements by clinching or other joining techniques.

In the case of the coating of metallic strip the production sequence may be that specified below, which indicates by way of example the sequence for steel sheets which are to be galvanized. This manufacturing sequence, where appropriate with omission of the coating with a metal or with an alloy such as in the case of galvanizing, may also be transferred to other metallic substrates and used in the same way.

Table 1: Manufacturing Sequence Variants in the Coating of steel sheet which is to be galvanized

1. Electrolytic cleaning with a strong alkaline cleaner to clean the surface entirely of organic impurities such as fat and oil, for example, and of other dirt.

2. Rinsing with water in a rinsing cascade, final zone with fully deionized water.

3. Only in the case of electrolytic galvanizing: acid pickling: spray briefly with water containing sulfuric acid, with a pH of 1 to 2.

4. Galvanizing: hot-dip galvanizing by dipping in melt bath or electrolytic galvanizing by dipping in a bath containing an aqueous zinc solution: coating with industrial-purity zinc, which may contain certain impurities, particularly of aluminum and lead (HDG); coating with a relatively iron-rich or aluminum-rich zinc alloy such as Galvanneal®, Galfan® or Galvalume®.

5. In the case of electrolytic galvanizing: following the deposition of the galvanizing layer, acidic pickling to remove unevennesses in the galvanizing layer.

6. Especially when phosphate layers are to be applied: coating with an activating solution based in particular on titanium.

7. Optional application of a first anticorrosion layer, e.g., as prephosphating.

8. Optional rinsing with water or, where appropriate, afterrinse solution; after prephosphating, only water.

9. Optional application of a second anticorrosion layer, e.g., an alkaline Fe-Co oxide layer.

10. Optional rinsing with water.

11. Optional application of a third anticorrosion layer e.g. based on hexafluoride.

12. Optional rinsing with water.

13. Optional application of a first paintlike coating.

14. Optional UV irradiation for crosslinking the paintlike coating.

15. Optional heating at temperatures in the range from 50 to 160° C. for thermal crosslinking of the paintlike coating.

16. Optional application of a second paintlike coating, referred to as the paint interlayer.

17. Optional UV irradiation for crosslinking the second paintlike coating.

18. Optional heating at temperatures in the range from 50 to 160° C. for thermal crosslinking of the second paintlike coating.

19. Optional application of a first paint layer as surfacer or topcoat, modified where appropriate with a content of nanoparticles.

20. Optional application of a second paint layer as surfacer or topcoat, modified where appropriate with a content of nanoparticles.

21. Optional application of a third paint layer as topcoat, modified where appropriate with a content of nanoparticles.

22. Optional heating at temperatures in the range from 50 to 160° C. for thermal crosslinking (curing) of the paint layer(s).

23. Optional UV irradiation for crosslinking the final paint layer.

In the table below the abovementioned process steps—by way of example for steel sheet which is to be galvanized—are assigned to the possible manufacturing lines, the specific sequences, and any agents to be used therein. The assignment of particular process steps to the manufacturing line is, however, in each case only one of several possibilities. Manufacturing line Zn=galvanizing line. Manufacturing line CC=coil coating. Manufacturing line bodywork parts manufacture or bodywork manufacture or corresponding manufacturing line in aircraft construction or space travel industry=bod. Z=number of process steps without all possible intermediate steps which may be necessary, such as pickling, cleaning, activating, rinsing or afterrinsing, and/or drying, for example. These method variants apply very substantially in the same way for other metallic materials as well, where appropriate without galvanizing.

TABLES 2A-J
Variants of the assignment of process
steps and manufacturing lines in the case of steel
sheet which is to be galvanized, disregarding
intermediate steps
Variants A

| | | | Basis of the |
|---|---|---|---|
| Line | Z | Process step | principal agents |
| Zn | 1 | Galvanizing | zinc, ZnFe, ZnAl |
| | 2 | pretreatment, rinse or | chromate, Fe/Co/Ni |
| | | no-rinse, optional | oxide, free fluoride, |
| | | afterrinse | complex fluoride, |
| | | | phosphate, phosphonate, |
| | | | rare earths, silane, |
| | | | silicate and/or polymer |
| CC | 3 | optional mild-alkaline | |
| | | cleaning | |
| | 4 | chromium-containing or | chromate, Fe/Co/Ni |
| | | chromium-free | oxide, free fluoride, |
| | | pretreatment | complex fluoride, |
| | | | phosphate, phosphonate, |
| | | | rare earths, silane, |
| | | | silicate and/or polymer |
| | 5 | Basecoat | coil coating primer, |
| | | | lubricating or welding |
| | | | primer: UV curing and/or |
| | | | thermosetting |
| CC or | 6 | Optional paint | |
| bod | | interlayer | |
| | 7 | color coat | |
| | 8 | clearcoat, optionally | |
| | | two layers | |
| bod | 9 | cutting, pressing | |
| | | and/or stamping | |
| | 10 | optional (further) | |
| | | forming | |
| | 11 | optional joining such | |
| | | as clinching, bonding, | |
| | | for example | |
| | 12 | optional clearcoat | |

Variants B

| Line | Z | Process step | Principal Agents |
|---|---|---|---|
| Zn | 1 | galvanizing | zinc, ZnFe, ZNAl |
| | 2 | pretreatment, rinse or | chromate, Fe/Co/Ni |
| | | no-rinse, optional | oxide, free fluoride, |
| | | afterrinse | complex flouride, |
| | | | phosphate, phosphonate, |
| | | | rare earths, silane, |
| | | | silicate and/or polymer |
| CC | 3 | optional mild-alkaline | |
| | | cleaning | |
| | 4 | basecoat, optionally | coil coating primer, |
| | | with pretreatment | lubricating primer or |
| | | properties | welding primer: UV |
| | | | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| CC or | 5 | optional paint | |
| bod | | interlayer | |
| | 6 | color coat | |
| | 7 | clearcoat, optionally | |
| | | two layers | |
| bod | 8 | cutting, pressing | |
| | | and/or stamping | |
| | 9 | optional (further) | |
| | | forming | |
| | 10 | optional joining such | |
| | | as clinching, bonding, | |
| | | for example | |
| | 11 | optional clearcoat | |

Variants C

| Line | Z | Process step | Principal agents |
|---|---|---|---|
| Zn | 1 | galvanizing | zinc, ZnFe, ZnAl |
| | 2 | pretreatment, rinse or | chromate, Fe/Co/Ni |
| | | no-rinse, optional | oxide, free fluoride, |
| | | afterrinse | complex fluoride, |
| | | | phosphate, phosphonate, |
| | | | rare earths, silane, |
| | | | silicate and/or polymer |
| | 3 | basecoat, optionally | coil coating primer, |
| | | with pretreatment | lubricating primer or |
| | | properties | welding primer: UV |
| | | | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| Zn* | 4 | optional paint | |
| | | interlayer | |
| CC or | 5 | color coat | |
| bod | | | |
| | 6 | clearcoat, optionally | |
| | | two layers | |
| bod | 7 | cutting, pressing | |
| | | and/or stamping | |
| | 8 | optional (further) | |
| | | forming | |
| | 9 | optional joining such | |
| | | as clinching, bonding, | |
| | | for example | |
| | 10 | optional clearcoat | |

*where appropriate, alternatively on CC or bod

Variants D

| Line | Z | Process step | Principal agents |
|---|---|---|---|
| Zn | 1 | galvanizing | zinc, ZnFe, ZnAl |
| | 2 | pretreatment, rinse or | chromate, Fe/Co/Ni |
| | | no-rinse, optional | oxide, free fluoride, |
| | | afterrinse | complex fluoride, |
| | | | phosphate, phosphonate, |
| | | | rare earths, silane, |
| | | | silicate and/or polymer |
| Zn or | 3 | basecoat, optionally | coil coating primer, |
| CC | | with pretreatment | lubricating primer or |
| | | properties | welding primer: UV |
| | | | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| CC or | 4 | optional paint | |
| bod | | interlayer | |
| | 5 | color coat | |
| | 6 | clearcoat, optionally | |
| | | two layers | |
| bod | 7 | cutting, pressing | |
| | | and/or stamping | |
| | 8 | optional (further) | |
| | | forming | |
| | 9 | optional joining such | |
| | | as clinching, bonding, | |
| | | for example | |
| | 10 | optional clearcoat | |

Variants E

| Line | Z | Process step | Principal agents |
|---|---|---|---|
| Zn | 1 | galvanizing | zinc, ZnFe, ZnAl |
| | 2 | basecoat with | coil coating primer, |
| | | pretreatment properties | lubricating primer or |
| | | | welding primer: UV |
| | | | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| Zn* | 3 | optional paint | |
| | | interlayer | |
| CC or | 4 | color coat | |
| bod | 5 | clearcoat, optionally | |
| | | two layers | |
| bod | 6 | cutting, pressing | |
| | | and/or stamping | |
| | 7 | optional (further) | |
| | | forming | |
| | 8 | optional joining such | |
| | | as clinching, bonding, | |
| | | for example | |
| | 9 | optional clearcoat | |

*where appropriate, alternatively on CC or bod

Variants F

| Line | Z | Process step | Principal agents |
|---|---|---|---|
| Zn | 1 | galvanizing | zinc, ZnFe, ZnAl |
| | 2 | basecoat with | coil coating primer, |
| | | pretreatment | lubricating primer or |
| | | properties, preferably | welding primer: UV |
| | | UV-curing | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| Zn* | 3 | optional paint | |
| | | interlayer | |
| CC or | 4 | color coat, preferably | |
| bod | | UV-curing | |
| | 5 | clearcoat, preferably | |
| | | UV- curing | |
| bod | 6 | cutting, pressing | |
| | | and/or stamping | |
| | 7 | optional (further) | |
| | | forming | |
| | 8 | optional joining such | |
| | | as clinching, bonding, | |
| | | for example | |
| | 9 | optional clearcoat, | |
| | | preferably UV-curing | |

*where appropriate, alternatively on CC or bod

Variants G

| Line | Z | Process step | Principal agents |
|---|---|---|---|
| Zn | 1 | Galvanizing | zinc, ZnFe, ZnAl |
| | 2 | pretreatment, rinse or | chromate, Fe/Co/Ni |
| | | no-rinse, optional | oxide, free fluoride, |
| | | afterrinse | complex fluoride, |
| | | | phosphate, phosphonate, |
| | | | rare earths, silane, |
| | | | silicate and/or polymer |
| | 3 | basecoat, optionally | coil coating primer, |
| | | with pretreatment | lubricating primer or |
| | | properties, preferably | welding primer: UV |
| | | UV-curing | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| Zn* | 4 | optional paint | |
| | | interlayer | |
| bod | 5 | cutting, pressing | |
| | | and/or stamping | |
| | 6 | optional (further) | |
| | | forming | |
| | 7 | optional joining such | |
| | | as clinching, bonding, | |
| | | welding | |
| | 8 | color coat, preferably | |
| | | UV-curing | |
| | 9 | clearcoat, optionally | |
| | | two layers, preferably | |
| | | UV-curing | |

*where appropriate, alternatively on CC or bod

Variants H

| Line | Z | Process step | Principal agents |
|---|---|---|---|
| Zn | 1 | galvanizing | zinc, ZnFe, ZnAl |
| | 2 | basecoat with | coil coating primer, |
| | | pretreatment | lubricating primer or |
| | | properties, preferably | welding primer: UV |
| | | UV-curing | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| Zn* | 3 | optional paint | |
| | | interlayer | |
| bod | 4 | cutting, pressing | |
| | | and/or stamping | |
| | 5 | optional (further) | |
| | | forming | |
| | 6 | optional joining such | |
| | | as clinching, bonding, | |
| | | welding | |
| | 7 | color coat, preferably | |
| | | UV-curing | |
| | 8 | clearcoat, optionally | |
| | | two layers, preferably | |
| | | UV-curing | |

*where appropriate, alternatively on CC or bod

Variants J

| Line | Z | Process step | Principal agents |
|---|---|---|---|
| Zn | 1 | galvanizing | zinc, ZnFe, ZnAl |
| | 2 | basecoat with | coil coating primer, |
| | | pretreatment properties | lubricating primer or |
| | | | welding primer: UV |
| | | | curing and/or |
| | | | thermosetting; chromate, |
| | | | free fluoride, complex |
| | | | fluoride, phosphate, |
| | | | phosphonate, rare |
| | | | earths, silane, |
| | | | silicate, corrosion |
| | | | inhibitor, pigment, |
| | | | polymer and/or wax |
| CC* | 3 | optional paint | |
| | | interlayer | |
| | 4 | color coat, possibly | |
| | | UV-curing | |
| bod | 5 | cutting, pressing | |
| | | and/or stamping | |
| | 6 | optional (further) | |
| | | forming | |
| | 7 | optional joining such | |
| | | as clinching, bonding, | |
| | | welding | |
| | 8 | clearcoat, optionally | |
| | | two layers, possibly | |
| | | UV-curing | |

*could also run on other manufacturing lines such as Zn or bod

The table below illustrates which metallic substrates or metallic coatings are coated onto substrates with at least one anticorrosion layer and/or with at least one paintlike coating, and which composition the anti-corrosion layer preferably possesses in this case.

TABLE 3
Correlation between preferred chemical basis
of anticorrosion layers or corresponding pretreatment
solutions with metallic substrate or metallic coating
on a substrate, respectively: goes very well: ⊕,
good: x, possible: •. 1., 2., and 3. show different
coatings following one another.

| Chem. basis of | | | | | | Zn |
|---|---|---|---|---|---|---|
| individual | Al/ | | | | | alloy, |
| anticorrosion layers | Al | Mg | iron/ | Stainless | | AlZn |
| and/or their baths | alloy | alloy | steel | steel | Zn | alloy |
| Oxalate | • | • | • | ⊕ | • | • |
| 1. oxalate, 2. chromate | • | • | • | ⊕ | • | • |
| 1. oxalate, 2. polymer | • | • | • | ⊕ | • | • |
| afterrinse solution | | | | | | |
| 1. Fe/co oxide, | | • | | | ⊕ | ⊕ |
| 2. AlZrF₆ | | | | | | |
| Ti and/or Zr hexa- | ⊕ | x | ⊕ | x | ⊕ | ⊕ |
| fluoride | | | | | | |
| Ti and/or Zr hexa- | ⊕ | • | ⊕ | x | ⊕ | ⊕ |
| fluoride with SiO₂ | | | | | | |
| 1. Ti and/or Zr hexa- | ⊕ | x | ⊕ | • | ⊕ | ⊕ |
| fluoride, 2. silane(s) | | | | | | |
| 1. Ti and/or Zr hexa- | ⊕ | • | ⊕ | • | ⊕ | ⊕ |
| fluoride, 2. Mn phos- | | | | | | |
| phate | | | | | | |
| 1. Ti and/or Zr hexa- | ⊕ | ⊕ | • | • | • | • |
| fluoride, 2. phos- | | | | | | |
| phonate(s) | | | | | | |
| 1. Ti and/or Zr hexa- | ⊕ | ⊕ | ⊕ | • | x | x |
| fluoride, 2. phos- | | | | | | |
| phonate(s), | | | | | | |
| 3. silane(s) | | | | | | |
| Rare earth element(s) | ⊕ | • | | | | |
| as nitrate(s) | | | | | | |
| Rare earth element(s) | ⊕ | • | • | | • | • |
| with Bi, peroxide and | | | | | | |
| chloride | | | | | | |
| Al phosphate | x | • | x | x | x | x |
| Fe phosphate | x | • | x | x | x | x |
| Mn phosphate | ⊕ | • | ⊕ | • | ⊕ | ⊕ |
| Zn phosphate | ⊕ | • | ⊕ | • | ⊕ | ⊕ |
| ZnMn phosphate | ⊕ | • | ⊕ | • | ⊕ | ⊕ |
| MnZn phosphate | ⊕ | • | ⊕ | x | ⊕ | ⊕ |
| 1. phosphate, | ⊕ | x | ⊕ | • | ⊕ | ⊕ |
| 2. chromate afterrinse | | | | | | |
| solution | | | | | | |
| 1. phosphate, 2. Ti/ZrF₆ | ⊕ | x | ⊕ | • | ⊕ | ⊕ |
| afterrinse solution | | | | | | |
| 1. phosphate, | ⊕ | • | ⊕ | • | ⊕ | ⊕ |
| 2. polymer afterrinse | | | | | | |
| solution | | | | | | |
| Zn/Mn phosphate with | x | • | ⊕ | • | ⊕ | ⊕ |
| polymer and Ti/ZrF₆ | | | | | | |
| Zn/Mn phosphate with | x | • | ⊕ | • | ⊕ | ⊕ |
| polymer, Ti/ZrF₆, and | | | | | | |
| nanoparticle | | | | | | |
| Polymer | • | • | • | • | • | • |
| Polymer with lubricant | x | • | x | x | x | x |
| Polymer with | ⊕-• | ⊕-• | ⊕-• | ⊕-• | ⊕-• | ⊕-• |
| nanoparticle* | | | | | | |
| Polymer with lubricant | ⊕ | ⊕ | ⊕ | ⊕-x | ⊕ | ⊕ |
| and nanoparticle* | | | | | | |
| Polymer with lubricant, | ⊕ | ⊕ | ⊕ | ⊕-x | ⊕ | ⊕ |
| corrosion inhibitor, | | | | | | |
| and nanoparticle | | | | | | |
| Polymer with lubricant, | ⊕ | ⊕-• | ⊕ | ⊕-x | ⊕ | ⊕ |
| complex fluoride, | | | | | | |
| corrosion inhibitor, | | | | | | |
| and nanoparticle | | | | | | |
| Polymer with lubricant, | ⊕ | ⊕-• | ⊕ | ⊕-x | ⊕ | ⊕ |
| complex fluoride, | | | | | | |
| corrosion inhibitor, | | | | | | |
| nanoparticle, and | | | | | | |
| phosphate | | | | | | |
| Phosphonate | ⊕ | x | | | x | x |
| Silane(s)/siloxane(s) | ⊕ | x | ⊕ | • | ⊕ | ⊕ |
| Silane with Ti/ZrF₆ | ⊕ | x | ⊕ | | ⊕ | ⊕ |

in the case of phosphate contents: where appropriate with addition of nickel
*depending on polymer content and nanoparticle content, very good especially in the case where at least one corrosion inhibitor and/or crosslinking agent is/are present

The method of the invention is particularly advantageous since in the short term at least some and in the medium term all of the chemical and coatings technology operating steps can be moved from the automobile plant to the steelworks or aluminum/magnesium mill. There, these sections of the method can run on high-speed manufacturing lines, in particular on strip lines, and so can be utilized with a timesaving, much more uniformly, more environmentally friendly, with savings of chemicals, water, space, energy, and costs, and with higher quality. Correspondingly, the costs of the pretreated, painted and, where appropriate, formed parts are much lower per fabricated square meter of the coated surface. Lower quantities of sludge are obtained in this process than in the case of the mode of manufacturing to date, especially during pretreatment and painting. Indeed, the baths in question have much lower volumes. Instead of about 20 to 250 m³, a typical bath volume is now only 5 to 15 m³. While pretreatment and painting take place at present in a large automobile plant usually with 3 000 to 5 000 m²/h, a throughput of about 8 000 to 30 000 m²/h can be achieved on strip lines. The overall time for cleaning and pretreatment can be lowered from 20 to 40 minutes to 15 to 30 seconds. The weight of the pretreatment coating can in some cases be lowered from 1.5 to 4 g/m² to about 0.01 to 2 g/m 2. The chemical consumption in the pretreatment can be lowered from 20 to 40 g/m² to 1 to 10 g/m². Instead of 15 to 40 g of sludge per m² of coated surface, now only 0 to 6 g per m² are produced. The painting and baking time can be reduced from 120 to 180 minutes to 0.1 to 2 minutes—for 2 layers of paint in each case. The paint consumption falls, for 3 paint layers with 200 to 300 g/m², to 80 to 120 g/m² for 2 paint layers. The overall costs could fall approximately by from 5 to 20% of the present overall costs per m² of coated surface.

It was surprising that with a synthetic resin coating, despite a thickness of only about 0.2 μm, it was possible to produce an extremely high-quality chromium-free film on the anticorrosion coating of the invention which produces extraordinarily firm adhesion of paint to the coating of the invention.

If paint layers or paintlike layers can be applied on the strip and not as part of the parts or bodywork manufacturing operation, the costs as compared with parts or bodywork manufacturing can be lowered significantly. Consequently, manufacturing on a strip, such as on a coil coating line in the parts manufacture or bodywork manufacture operation, is to be preferred.

### EXAMPLES

The examples described hereinbelow are intended to illustrate the subject matter of the invention. The recorded concentrations and compositions relate to the treatment solution itself and not to any more highly concentrated batch solutions that may be used. All concentration figures are to be understood as solids fractions; that is, the concentrations relate to the weight fractions of the effective components irrespective of whether the raw materials used were in dilute form, e.g., as aqueous solutions. The surface treatment of the metal test sheets took place always in the same way and included in particular the following steps:

I. alkaline cleaning in a spray process with Gardoclean® S5160

II. rinsing with water

III. rinsing with fully deionized water

IV. application of the treatment solutions according to the invention using a Chemcoater

V. drying in a circulating-air oven (PMT: 60 to 80° C.)

VI. coating of the pretreated surfaces with coil coating paint systems (primer and topcoat).

For the experiments a polyethylene-acrylate copolymer was chosen, having an acid number of about 30 and a melting range at a temperature in the range from 65 to 90° C. The polyacrylic acid-vinyl phosphonate copolymer used had an acid number of about 620 and its 5% strength aqueous solution a pH of fairly precisely 2.0. The polyacrylic acid employed was industrial-purity polyacrylic acid having an acid number of about 670 and having a molecular weight of approximately 100 000 u. In the case of the silanes used the industrial-purity compounds were added which hydrolyzed in the aqueous composition and which in particular during drying and curing were converted into siloxanes.

All inventive examples were prepared without the addition of an organic solvent. In certain examples, e.g., in the case of examples 1 to 4 and 8 to 10 and also in the case of example 15, the pH was adjusted to the value indicated in table 1 by adding ammonia. Otherwise, no additives not set out in the examples were added. It is, however, possible for small amounts of additives to have already been added by the manufacturer of the base materials. The remainder to 100% by weight or to 1 000 g/L gives the water content.

The mixing of the individual components was generally able to be carried out in any order. When adding manganese carbonate, zirconium ammonium carbonate or aluminum hydroxide, however, it is necessary to ensure that these substances are initially dissolved in the concentrated acidic components before the major amount of water is added. In the case of the addition of aluminum hydroxide or manganese carbonate, care is taken to ensure that these substances are present fully dissolved in the aqueous composition.

### Inventive example 1

Steel sheets obtained from commercial cold-rolled steel strip were first of all degreased in an alkaline spray cleaner and then treated with the aqueous composition of the invention. A defined amount of the treatment solution was applied so as to give a wet film thickness of about 6 ml/m². Besides water and fluoro complexes of titanium and of zirconium the treatment solution contained water-soluble copolymers based on acrylate and an organic phosphorus-containing acid and also an aqueous dispersion of inorganic particles in the form of fumed silica. The composition of the solution was as follows:

| | |
|---|---|
| 1.6 g/L | hexafluorozirconic acid, |
| 0.8 g/L | hexafluorotitanic acid, |
| 2 g/L | polyacrylic acid-vinyl phosphonate |
| | copolymer, |
| 2 g/L | SiO₂ (as fumed silica), |
| 1 g/L | citric acid. |

The silica dispersion contained particles having an average diameter, measured by scanning electron microscopy, in the range from about 20 to 50 nm. The constituents were mixed in the order indicated and the pH of the solution was then adjusted to 4.5 using a fluoride-containing ammonia solution. The aqueous composition contained 3.4 g/L acids, 4 g/L solids, and otherwise only water. Following application, the solution was dried in a circulation-air oven at approximately 70° C. PMT (peak metal temperature). The steel panels pretreated in this way were coated with a commercially customary chromium-free coil coating paint system.

### Inventive Example 2

Steel panels were treated as described in Example 1 but with a composition containing as transition metal only titanium and containing inorganic particles in the form of an aqueous colloidal silica dispersion:

| | |
|---|---|
| 2 g/L | hexafluorotitanic acid, |
| 2 g/L | polyacrylic acid-vinyl phosphonate |
| | copolymer, |
| 2 g/L | SiO₂ (as colloidal silica dispersion), |
| 0.5 g/L | citric acid. |

The silica dispersion contained particles having an average diameter, measured by scanning electron microscopy, in the range from about 8 to 20 nm.

### Inventive Example 3

Steel panels were treated as described in Example 1 but with a composition additionally containing a hydrolyzed alkoxysilane as coupling reagent:

| | |
|---|---|
| 2 g/L | hexafluorozirconic acid, |
| 2 g/L | polyacrylic acid-vinyl phosphonate |
| | copolymer, |
| 2 g/L | SiO₂ (as colloidal silica dispersion), |
| 2.5 g/L | aminopropyltrimethoxysilane (AMEO). |

For the preparation of the bath the silane compound was first hydrolyzed in a solution in acetic acid, with stirring for a number of hours, before the remaining constituents were added. A pH of 5 was then set.

### Inventive Example 4

Starting from a water-insoluble polyethylene-acrylic acid copolymer, a stable aqueous dispersion with a solids content of 25% was obtained by adding a suitable amount of an ammonia solution at about 95° C. with stirring and reflux cooling. The dispersion obtained in this way was used to prepare a treatment solution whose composition was as follows:

| | |
|---|---|
| 5 g/L | polyethylene-acrylate copolymer (as |
| | aqueous dispersion), |
| 2 g/L | zirconium ammonium carbonate, |
| 10 g/L | SiO₂ (as fumed silica). |

The pH of the treatment solution was adjusted to 8.5.

Care was taken to ensure that the pH of the solution does not fall below a value of 7.5 during the preparation, since otherwise precipitations of the polymer or of the fumed silica would have been possible. Furthermore, care was taken to ensure that the drying of the film takes place at a PMT of at least 80° C. Otherwise, the treatment of the steel strip was as described in Example 1.

### Inventive Example 5

Hot-dip-galvanized (HDG) steel panels with a zinc fraction of more than 95% in the galvanizing layer were subjected, in the same way as the steel panels in the examples described above, to cleaning, degreasing, and a surface treatment with the composition described below:

| | |
|---|---|
| 2 g/L | hexafluorotitanic acid, |
| 1.8 g/L | polyacrylic acid (molecular weight: |
| | about 100 000), |
| 5 g/L | SiO₂ (as fumed silica). |

The constituents were combined in the stated order in aqueous solution or dispersion.

### Inventive Example 6

Hot-dip-galvanized steel panels were treated in analogy to Example 5 but with a composition which contained inorganic particles in the form of a colloidal solution:

| | |
|---|---|
| 2 g/L | hexafluorozirconic acid, |
| 1.8 g/L | polyacrylic acid (molecular weight: |
| | about 100 000), |
| 2 g/L | SiO₂ (as colloidal silica dispersion). |

The particles present in the composition had an average diameter in the range from 12 to 16 nm.

### Inventive Example 7

Hot-dip-galvanized steel panels were treated in analogy to Example 6 but with a treatment solution in which the fraction of inorganic particles was increased fivefold as compared with the composition indicated in Example 6:

| | |
|---|---|
| 2 g/L | hexafluorozirconic acid, |
| 1.8 g/L | polyacrylic acid (molecular weight: |
| | about 100 000), |
| 10 g/L | SiO₂ (as colloidal silica dispersion). |

The increase in the particle concentration beyond optimum levels led to a deterioration in particular in the adhesion properties of a subsequently applied further organic coating or paint system.

### Inventive Example 8

In a manner similar to that of Example 3 for steel surfaces, hot-dip-galvanized steel panels were treated with a composition containing, besides fluorometallate, polymers, and inorganic particles, a silane hydrolyzed in aqueous solution. The treatment solution was composed of the following constituents:

| | |
|---|---|
| 2 g/L | hexafluorozirconic acid, |
| 1.8 g/L | polyacrylic acid (molecular weight: |
| | about 100 000), |
| 4 g/L | SiO₂ (as colloidal silica dispersion), |
| 2.5 g/L | 3-glycidyloxypropyltrimethoxysilane |
| | (GLYMO). |

For the preparation, the silane component was first hydrolyzed in aqueous solution, and then the remaining constituents were added.

### Inventive Example 9

In a manner similar to that of Inventive Example 4 for steel surfaces, hot-dip-galvanized steel panels were coated with an alkalified treatment solution with a pH of 9 whose composition was as follows:

| | |
|---|---|
| 5 g/L | polyethylene-acrylate copolymer (as |
| | aqueous dispersion), |
| 2 g/L | zirconium ammonium carbonate, |
| 4 g/L | SiO₂ (as colloidal silica dispersion). |

Here again the temperature of the panel surface during the drying of the film was at least 80° C.

### Inventive Example 10

Hot-dip-galvanized steel surfaces were treated in accordance with the preceding example, Example 9, with an alkaline composition having a pH of 9 which in addition to the polymer dispersion and the Zr component contained an aqueous dispersion of TiO₂ particles having an average size of 5 nm and whose composition was as follows:

| | |
|---|---|
| 5 g/L | polyethylene-acrylate copolymer (as |
| | aqueous dispersion), |
| 2 g/L | zirconium ammonium carbonate, |
| 4 g/L | TiO₂ (as aqueous dispersion). |

### Inventive Example 11

In accordance with Inventive Example 10, hot-dip galvanized steel surfaces were treated with a TiO₂ containing composition which, however, in contrast to the preceding example, had an acidic pH of 3 and contained aluminum ions as well as the titanium and zirconium compounds.

| | |
|---|---|
| 3 g/L | hexafluorozirconic acid, |
| 2 g/L | hexafluorotitanic acid, |
| 0.3 g/L | Al(OH)₃, |
| 2 g/L | polyacrylic acid (molecular weight: |
| | about 100 000), |
| 4 g/L | TiO₂ (as aqueous dispersion). |

In comparison to the SiO₂-containing compositions, the TiO₂-containing treatment solutions generally have further improved corrosion control properties in particular on hot-dip-galvanized surfaces. However, the storage stability of these compositions is significantly reduced as compared with the SiO₂— containing solutions.

### Inventive Example 12

In accordance with Inventive Example 11, hot-dip-galvanized steel panels were treated with a composition which additionally contained manganese ions:

| | |
|---|---|
| 3 g/L | hexafluorozirconic acid, |
| 2 g/L | hexafluorotitanic acid, |
| 0.3 g/L | Al(OH)₃, |
| 2 g/L | polyacrylic acid (molecular weight: |
| | about 100 000), |
| 4 g/L | TiO₂ (as aqueous dispersion), |
| 1 g/L | MnCO₃. |

The addition of Mn to the treatment solution enhances first the corrosion control effect of the coating and in particular increases the resistance of the layer to alkaline media such as, for example, to cleaning products which are customary in strip coating.

### Inventive Example 13

In accordance with Inventive Example 12, hot-dip-galvanized steel panels were treated with a composition which, instead of the TiO₂ dispersion, contained a colloidal silica dispersion:

| | |
|---|---|
| 3 g/L | hexafluorozirconic acid, |
| 2 g/L | hexafluorotitanic acid, |
| 0.3 g/L | Al(OH)₃, |
| 2 g/L | polyacrylic acid (molecular weight: |
| | about 100 000), |
| 2 g/L | SiO₂ (as colloidal silica dispersion), |
| 1 g/L | MnCO₃. |

The addition of Mn to the treatment solution enhances first the corrosion control effect of the coating and in particular increases the resistance of the layer to alkaline media such as, for example, to cleaning products which are customary in strip coating. Instead of the TiO₂ dispersion, colloidal SiO₂ was added.

### Inventive Example 14

In accordance with Inventive Example 14, hot-dip-galvanized steel panels were treated with a composition which contained no hexafluorotitanic acid and a somewhat reduced amount of hexafluorozirconic acid and of polyacrylic acid:

| | |
|---|---|
| 2 g/L | hexafluorozirconic acid, |
| 0.3 g/L | Al(OH)₃, |
| 1.8 g/L | polyacrylic acid (molecular weight: |
| | about 100 000), |
| 2 g/L | SiO₂ (as colloidal silica dispersion), |
| 1 g/L | MnCO₃. |

The addition of Mn to the treatment solution enhances first the corrosion control effect of the coating and in particular increases the resistance of the layer to alkaline media such as, for example, to cleaning products which are customary in strip coating. In comparison with Example 13, the H₂TiF₆ content was omitted and the H₂ZrF₆ content reduced. This gave an improvement in paint adhesion.

### Inventive Example 15

In accordance with Inventive Example 14, hot-dip-galvanized steel panels were treated with a composition which had no aluminum hydroxide content:

| | |
|---|---|
| 2 g/L | hexafluorozirconic acid, |
| 1.8 g/L | polyacrylic acid (molecular weight: |
| | about 100 000), |
| 2 g/L | SiO₂ (as colloidal silica dispersion), |
| 1 g/L | MnCO₃. |

The addition of Mn to the treatment solution enhances first the corrosion control effect of the coating and in particular increases the resistance of the layer to alkaline media such as, for example, to cleaning products which are customary in strip coating. The pH was adjusted by adding ammonia. In comparison to Example 14 the addition of aluminum hydroxide was omitted.

### Inventive Example 16

Starting from the composition of Example 9, the amount of polyethylene acrylate was raised from 5 to 10 g/L. As a result, the coating of the invention becomes thicker.

### Inventive Example 17

In accordance with Inventive Example 16 the composition of Example 16 was given the further addition of 0.5 g/L of polyethylene wax having a melting point in the range from 125 to 165° C. This greatly improved the lubricity of the coating.

### Inventive Example 18

The corrosion inhibitor diethylthiourea was added at 1.0 g/L to the aqueous inventive composition of Example 14, producing some extra increase in the corrosion resistance and achieving a greater reliability for line production.

### Comparative Example 1

Since the corrosion testing results and assessments of paint adhesion tests are generally highly dependent on the paint system used and on the specific test conditions, absolute values of such test results are of only limited meaningfulness. Consequently, in conducting the experiments described in the inventive examples, comparatively, samples of material were always coated with a chromating process in accordance with the state of the art, which led to a chromium add-on of about 20 mg/m². For this purpose, Gardobond® C4504 (Chemetall GmbH) with a bath concentration of 43 g/L of the commercial concentrate, was applied in the same way as the aforementioned solutions, dried in the circulating-air oven, and then coated with coil coating paints.

### Comparative Example 2

The inorganic compounds in particle form that are used in the process of the invention are critical for the adhesion of a subsequently applied further organic coating and for the corrosion properties of the assembly composed of metal, inventive pretreatment, and organic coating. As a comparative experiment, therefore, steel surfaces were treated with an aqueous composition which largely corresponded, in terms of its ingredients, to the process of the invention but did not contain the important addition of the inorganic particles. Specifically, the composition contained

| | |
|---|---|
| 2 g/L | hexafluorotitanic acid, |
| 2 g/L | polyacrylic acid-vinyl phosphonate |
| | copolymer, |
| 0.5 g/L | citric acid. |

In comparison to the equivalent composition described in Inventive Example 2, with the addition of a colloidal silica dispersion, the composition gave significantly reduced corrosion control.

### Comparative Example 3

Corresponding to the Comparative Example 2 for steel surfaces, hot-dip-galvanized steel panels were coated with a composition which contained inventive constituents but no inorganic compounds in particle form.

| | |
|---|---|
| 2 g/L | hexafluorotitanic acid, |
| 1.8 g/L | polyacrylic acid (molecular weight: |
| | about 100 000). |

In comparison to the equivalent composition described in Inventive Example 6, with the addition of a colloidal silica dispersion, the composition gave both a markedly reduced adhesion of a subsequently applied coil coating paint system and a markedly reduced corrosion control.

### Comparative Example 4

The choice of a suitable organic film former in the form of water-soluble or water-dispersible polymers is likewise of decisive importance for the corrosion control effect of the system and also for the adhesion of a subsequently applied coating. Not only the absence of a bath component but also the choice of a inappropriate polymer compound have a considerable adverse effect on corrosion control and paint adhesion. As an example of a polymer system which is unsuitable for the purposes of the invention, mention may be made of an aqueous solution of a polyvinylpyrrolidone from BASF. The composition of the bath solution was otherwise in accordance with the process of the invention.

| | |
|---|---|
| 2 g/L | hexafluorozirconic acid, |
| 2 g/l | polyvinylpyrrolidone (as an aqueous |
| | solution), |
| 2 g/L | SiO₂ (as a colloidal silica dispersion). |

Hot-dip-galvanized steel panels treated with this composition had a level of paint adhesion markedly reduced as compared with the comparable inventive examples and also a poorer corrosion control. The matter of which factors, at the molecular level, make a polymer system suitable for application for the purposes of the invention has not been adequately elucidated to date. The polymer systems indicated in the inventive examples as being suitable were found by screening techniques.

### Comparative Example 5

On aluminum surfaces in particular, some of the pretreatment processes employed contain, besides complex fluorides of zirconium or of titanium, no further constituents such as organic film formers or inorganic particles. On zinc surfaces or iron surfaces, however, such processes do not afford adequate corrosion control. This can be demonstrated by corrosion testing results obtained on hot-dip-galvanized steel surfaces following treatment with a composition containing hexafluorozirconic acid as its sole component. The aqueous composition of this comparative example contains 2 g/L hexafluorozirconic acid.

Table 1 shows, for comparison, the compositions of the experimental baths listed in the examples. Table 2 summarizes the results of the corrosion tests and paint adhesion tests on the coatings obtained with these compositions.

TABLE 1
Overview of the composition of the examples and comparative examples. “Polyacryl” stands
for polyacrylic acid, Zr(CO₃)₂ for a Zr ammonium carbonate.

| | | c | | c | Inorganic | c | Additives, | c | |
|---|---|---|---|---|---|---|---|---|---|
| Ex. | Zr, Ti, Cr | [g/L] | Polymer | [g/L] | particles | [g/L] | additions | [g/L] | pH |
| B 1 | H₂ZrF₆, | 1.6 | polyacryl/ | 2.0 | fumed SiO₂ | 2 | citric acid | 1.0 | 4.5 |
| | H₂TiF₆ | 0.8 | vinyl phosphonate | | | | | | |
| B 2 | H₂TiF₆ | 2.0 | polyacryl/ | 2.0 | colloidal SiO₂ | 2 | citric acid | 0.5 | 4.5 |
| | | | vinyl phosphonate | | | | | | |
| B 3 | H₂ZrF₆ | 2.0 | polyacryl/ | 2.0 | colloidal SiO₂ | 2 | AMEO | 2.5 | 5 |
| | | | vinyl phosphonate | | | | | | |
| B 4 | Zr(CO₃)₂ | 2.0 | polyethylene/acrylate | 5.0 | fumed SiO₂ | 10 | — | — | 8.5 |
| B 5 | H₂TiF₆ | 2.0 | Polyacryl | 1.8 | fumed SiO₂ | 5 | — | — | 2 |
| B 6 | H₂ZrF₆ | 2.0 | Polyacryl | 1.8 | colloidal SiO₂ | 2 | — | — | 2 |
| B 7 | H₂ZrF₆ | 2.0 | Polyacryl | 1.8 | colloidal SiO₂ | 10 | — | — | 2 |
| B 8 | H₂TiF₆ | 2.0 | Polyacryl | 1.8 | colloidal SiO₂ | 4 | GLYMO | 2.5 | 5 |
| B 9 | Zr(CO₃)₂ | 2.0 | polyethylene/acrylate | 5.0 | colloidal SiO₂ | 4 | — | — | 9 |
| B 10 | Zr(CO₃)₂ | 2.0 | polyethylene/acrylate | 5.0 | TiO₂ dispersion | 4 | — | — | 9 |
| B 11 | H₂ZrF₆, | 3.0 | Polyacryl | 2.0 | TiO₂ dispersion | 4 | Al(OH)₃ | 0.3 | 3 |
| | H₂TiF₆ | 2.0 | | | | | | | |
| B 12 | H₂ZrF₆, | 3.0 | Polyacryl | 2.0 | TiO₂ dispersion | 4 | Al(OH)₃ | 0.3 | 3 |
| | H₂TiF₆ | 2.0 | | | | | MnCO₃ | 1.0 | |
| B 13 | H₂ZrF₆, | 3.0 | Polyacryl | 2.0 | colloidal SiO₂ | 2 | Al(OH)₃ | 0.3 | 3 |
| | H₂TiF₆ | 2.0 | | | | | MnCO₃ | 1.0 | |
| B 14 | H₂ZrF₆ | 2.0 | Polyacryl | 1.8 | colloidal SiO₂ | 2 | Al(OH)₃ | 0.3 | 3 |
| | | | | | | | MnCO₃ | 1.0 | |
| B 15 | H₂ZrF₆ | 2.0 | Polyacryl | 1.8 | colloidal SiO₂ | 2 | MnCO₃ | 1.0 | 3 |
| B 16 | Zr(CO₃)₂ | 2.0 | polyethylene/acrylate | 10.0 | colloidal SiO₂ | 4 | — | — | 9 |
| B 17 | Zr(CO₃)₂ | 2.0 | polyethylene/acrylate | 10.0 | colloidal SiO₂ | 4 | polyethylene | 0.5 | 9 |
| | | | | | | | wax | | |
| B 18 | H₂ZrF₆ | 2.0 | Polyacryl | 1.8 | colloidal SiO₂ | 2 | Al(OH)₃ | 0.3 | 3 |
| | | | | | | | MnCO₃ | 1.0 | |
| | | | | | | | diethyl- | 1.0 | |
| | | | | | | | thiourea | | |
| CB1 | Gardobond ® C | 43 | — | — | — | — | — | — | 2 |
| | 4504 (Cr VI) | | | | | | | | |
| CB2 | H₂TiF₆ | 2 | polyacryl/vinyl | 2 | — | — | citric acid | 0.5 | 4.5 |
| | | | phosphate | | | | | | |
| CB3 | H₂TiF₆ | 2 | Polyacryl | 1.8 | — | — | — | — | 2 |
| CB4 | H₂ZrF₆ | 2 | polyvinylpyrrolidone | 2 | colloidal SiO₂ | 2 | — | — | 2 |
| CB5 | H₂ZrF₆ | 2 | — | — | — | — | — | — | 2 |

EXAMPLE 2
Results of the adhesion and corrosion control results.

| | | | | | Erichsen | Salt spray test | | VDA¹ cycling test | |
|---|---|---|---|---|---|---|---|---|---|
| | | | | | cupping | (DIN 50021) | | (VDA 621-415) | |
| | | Coatweight | | T-bend | after | U [mm] after | | U [mm] after | |
| | | for Zr and/or | | T1* | cross-cut* | 480 h | | 10 cycles | |
| | | Ti content | | (delamination | (delamination | scribe | | scribe | |
| Example | Substrate | mg/m² | | in %) | in %) | mark | edge | mark | edge |
| B 1 | steel | 4.2 | 1.4 | 5 | 0 | 5 | 4 | — | — |
| B 2 | steel | | 3.5 | 1 | 0 | 3.5 | 4 | — | — |
| B 3 | steel | 5.3 | | 5 | 2 | 3 | 4 | — | — |
| B 4 | steel | 5.2 | | 5 | 1 | 2 | 3 | — | — |
| B 5 | HDG | | 3.5 | 5 | 2 | 1 | 2.5 | 2 | 3 |
| B 6 | HDG | 5.3 | | 2 | 0 | 0.5 | 2 | 1 | 2.5 |
| B 7 | HDG | 5.3 | | 10 | 2 | 0.5 | 1.5 | 1 | 2.5 |
| B 8 | HDG | | 3.5 | 1 | 0 | 1 | 2 | 1 | 2.5 |
| B 9 | HDG | 5.1 | | 2 | 0 | 1.5 | 2 | 1 | 2 |
| B 10 | HDG | 5.3 | | 2 | 1 | 1.5 | 2 | 1 | 1.5 |
| B 11 | HDG | 7.9 | 3.5 | 10 | 1 | 1 | 1 | 0.5 | 1 |
| B 12 | HDG | 7.9 | 3.5 | 5 | 1 | 0.5 | 1 | 0.5 | 1 |
| B 13 | HDG | 7.9 | 3.5 | 5 | 1 | 1 | 1.5 | 0.5 | 1 |
| B 14 | HDG | 5.3 | | 1.5 | 1 | 0.5 | 0.75 | 0.5 | 0.5 |
| B 15 | HDG | 5.3 | | 2 | 1 | 0.5 | 1 | 0.5 | 1 |
| B 16 | HDG | 5.3 | | 5 | 1 | 1 | 1.5 | 0.5 | 1 |
| B 17 | HDG | 5.1 | | 5 | 1 | 1 | 1.5 | 0.5 | 1 |
| B 18 | HDG | 5.3 | | 1.5 | 1 | 0.5 | 0.5 | 0.5 | 0.5 |
| CB 1 | steel | — | | 0 | 0 | 0.5 | 0.5 | — | — |
| CB 1 | HDG | — | | 2 | 1 | 0.5 | 1 | 0.5 | 0.5 |
| CB 2 | steel | | 3.5 | 60 | 8 | 7 | 5.5 | — | — |
| CB 3 | HDG | | 3.5 | 70 | 10 | 6 | 7 | 3 | 4.5 |
| CB 4 | HDG | 5.3 | | 80 | 15 | 4 | 7 | 2 | 2.5 |
| CB 5 | HDG | 5.3 | | 60 | 6 | 3 | 5 | 2.5 | 4 |

¹VDA = German automakers association

Adhesion testing by means of the T-bend test was carried out in accordance with NCCA standard, i.e., in the case of a T1 bend the space between the panel halves bent around amounted to a panel thickness of about 1 mm, so that the bending diameter was approximately 1 mm. After this very severe bending, the paint adhesion was tested by adhesive tape removal experiments and the result was expressed as the percentage area fraction of paint flaking and delamination.

In the case of the Erichsen adhesion test, a crosswise cut was first made on the painted metal surface, and then an Erichsen cupping of 8 mm was performed. Here again, the paint adhesion was tested by adhesive tape removal experiments and the result expressed in the form of the percentage paint delamination.

The results make it clear that the treatment solutions of the invention give results comparable with the chromating process employed as standard in terms of the adhesion properties of a subsequently applied organic coating and in terms of the corrosion properties achievable with the coating system. From the comparative examples it is evident that the properties of the coating derive primarily from the correct choice of the polymers and of the inorganic particles. At the same time, the treatment process of the invention is able to operate both in the slightly alkaline and in the acidic pH range, given the selection of polymer systems suitable for the respective pH range.

From the cited examples it is possible to conclude in general that with acidic compositions in the pH range from 1 to 5 the corrosion control achieved is generally better than with alkaline compositions. Slightly alkaline treatment solutions may, however, be advantageous if the surfaces to be treated are steel surfaces or surfaces which have already been phosphated, where a pickling attack is to be kept as low as possible. The inorganic particles which are used in the treatment solutions ideally have a diameter in the range from 5 to 30 nm. Here, colloidal silica solutions are to be preferred over the corresponding pulverulent products of fumed silica, since they generally allow better adhesion properties to be achieved. This is probably attributable to the considerably broader particle size distribution of the fumed products. It was surprising that it was possible to develop for hot-dip-galvanized steel a coating at least equal to that of a typical chromate pretreatment.

Although the coatings of the inventive examples had a coat thickness only in the range from 0.01 to 0.2 μm, generally in the range from 0.02 or 0.03 to 0.1 μm, the quality of these coatings was outstanding.

1. A method of coating a metallic strip, the strip, or strip sections produced from it, where appropriate, in the subsequent operation, being first coated with at least one anticorrosion layer and then with at least one layer of a paintlike, polymer-containing layer and/or of at least one paint layer, the strip, after coating with at least one anticorrosion layer or after coating with at least one layer of a paintlike coating and/or of at least one paint layer, being divided into strip sections, the coated strip sections then being formed, joined and/or coated with at least one (further) paintlike layer and/or paint layer, at least one of the anticorrosion layers being formed by coating the surface with an aqueous dispersion which comprises besides water a) at least one organic film former comprising at least one water-soluble or water-dispersed polymer, b) an amount of cations and/or hexafluoro and/or tetrafluoro complexes of cations selected from the group of titanium, zirconium, hafnium, silicon, aluminum, and boron, and c) at least one inorganic compound in particle form having an average particle diameter, measured in a scanning electron microscope, in the range from 0.005 up to 0.2 μm diameter, the clean metallic surface being contacted with the aqueous composition and a particle-containing film being formed on the metallic surface, and subsequently dried and, where appropriate, additionally cured, the dried and, where appropriate, additionally cured film having a thickness in the range from 0.01 to 10 μm.

2. The method of claim 1, characterized in that a metallic surface of aluminum, iron, copper, magnesium, nickel, titanium, tin, zinc or alloys of aluminum, iron, copper, magnesium, nickel, titanium, tin and/or zinc, in particular of steel or galvanized steel surfaces, is coated.

3. The method of claim 1 or 2, characterized in that the organic film former is in the form of a solution, dispersion, emulsion, microemulsion and/or suspension.

4. The method of any of the above claims, characterized in that organic film former is at least one synthetic resin, in particular a synthetic resin based on acrylate, ethylene, polyester, polyurethane, silicone polyester, epoxide, phenol, styrene, urea-formaldehyde, derivatives thereof, copolymers, polymers, mixtures and/or addition copolymers.

5. The method of any of the above claims, characterized in that the organic film former is a synthetic resin mixture and/or addition copolymer which includes synthetic resin based on acrylate, polyacrylic, ethylene, polyethylene, urea-formaldehyde, polyester, polyurethane, polystyrene and/or styrene, and from which, during or after the emission of water and other volatile constituents, an organic film is formed.

6. The method of any of the above claims, characterized in that the organic film former comprises synthetic resins and/or polymers and/or derivatives, copolymers, polymers, mixtures and/or addition copolymers based on acrylate, polyacrylic, polyethyleneimine, polyurethane, polyvinyl alcohol, polyvinylphenol, polyvinylpyrrolidone and/or polyaspartic acid, especially copolymers with a phosphorus-containing vinyl compound.

7. The method of any of the above claims, characterized in that the acid number of the synthetic resins is in the range from 5 to 250.

8. The method of any of the above claims, characterized in that the molecular weights of the synthetic resins, copolymers, polymers and/or derivatives thereof, mixtures and/or addition copolymers are in the region of at least 1 000 u, preferably of at least 5 000 u, with particular preference from 20 000 to 200 000 u.

9. The method of any of the above claims, characterized in that the pH of the organic film former in an aqueous formulation, without the addition of further compounds, is in the range from 1 to 12.

10. The method of any of the above claims, characterized in that the organic film former contains only water-soluble synthetic resins and/or polymers, especially those which are stable in solutions with pH values <5.

11. The method of any of the above claims, characterized in that the organic film former contains synthetic resin and/or polymer which contain carboxyl groups.

12. The method of any of the above claims, characterized in that the acid groups of the synthetic resins have been stabilized with ammonia, with amines such as morpholine, dimethylethanolamine, diethylethanolamine or triethanolamine, for example, and/or with alkali metal compounds such as sodium hydroxide, for example.

13. The method of any of the above claims, characterized in that the aqueous composition contains from 0.1 to 50 g/L of the organic film former.

14. The method of any of the above claims, characterized in that the aqueous composition contains from 0.1 to 50 g/L of cations and/or hexafluoro complexes of cations selected from the group of titanium, zirconium, hafnium, silicon, aluminum, and boron.

15. The method of any of the above claims, characterized in that Mn ions are added to the aqueous composition in an amount in the range from 0.05 to 10 g/L.

16. The method of any of the above claims, characterized in that the amount of at least one silane and/or siloxane, calculated as silane, in the aqueous composition is preferably from 0.1 to 50 g/L.

17. The method of any of the above claims, characterized in that the aqueous composition comprises at least one partly hydrolyzed or completely hydrolyzed silane.

18. The method of any of the above claims, characterized in that at least one aminosilane, epoxysilane, vinylsilane and/or at least one corresponding siloxane is present.

19. The method of any of the above claims, characterized in that as inorganic compound in particle form a finely divided powder, a dispersion or a suspension such as, for example, a carbonate, oxide, silicate or sulfate is added, especially colloidal or amorphous particles.

20. The method of any of the above claims, characterized in that as inorganic compound in particle form particles having an average size in the range from 8 nm to 150 nm are used.

21. The method of any of the above claims, characterized in that as inorganic compound in particle form particles based on at least one compound of aluminum, barium, cerium, and/or other rare earth elements, calcium, lanthanum, silicon, titanium, yttrium, zinc and/or zirconium are added.

22. The method of any of the above claims, characterized in that as inorganic compound in particle form particles based on alumina, barium sulfate, cerium dioxide, silica, silicate, titanium oxide, yttrium oxide, zinc oxide and/or zirconium oxide are added.

23. The method of any of the above claims, characterized in that the aqueous composition comprises from 0.1 to 500 g/L of the at least one inorganic compound in particle form.

24. The method of any of the above claims, characterized in that as organic solvent for the organic polymers at least one water-miscible and/or water-soluble alcohol, one glycol ether or N-methylpyrrolidone and/or water is used, in the case of the use of a solvent mixture in particular a mixture of water with at least one long-chain alcohol, such as propylene glycol, for example, an ester alcohol, a glycol ether and/or butanediol, but preferably just water without organic solvent.

25. The method of any of the above claims, characterized in that the amount of organic solvent is from 0.1 to 10% by weight.

26. The method of any of the above claims, characterized in that as corrosion inhibitor an organic compound or an ammonium compound, in particular an amine or an amino compound, is added.

27. The method of any of the above claims, characterized in that as lubricant at least one wax selected from the group consisting of paraffins, polyethylenes, and polypropylenes is used, in particular an oxidized wax.

28. The method of claim 27, characterized in that the melting point of the wax used as lubricant is in the range from 40 to 160° C.

29. The method of any of the above claims, characterized in that the aqueous composition comprises where appropriate in each case at least one biocide, defoamer and/or wetting agent.

30. The method of any of the above claims, characterized in that an aqueous composition having a pH in the range from 0.5 to 12 is used.

31. The method of any of the above claims, characterized in that the aqueous composition is applied at a temperature in the range from 5 to 50° C. to the metallic surface.

32. The method of any of the above claims, characterized in that the metallic surface is held at temperatures in the range from 5 to 120° C. on application of the coating.

33. The method of any of the above claims, characterized in that the coated metallic surface is dried at a temperature in the range from 20 to 400° C. PMT (peak metal temperature).

34. The method of any of the above claims, characterized in that the coated strips are wound to a coil, where appropriate after cooling to a temperature in the range from 40 to 70° C.

35. The method of any of the above claims, characterized in that a standard coil coating paint F2-647, applied together with the topcoat paint F5-618 to the dried or cured film, produces an adhesive strength of not more than 10% of the delaminated area in a T-bend test with a T1 bend in accordance with NCCA.

36. The method of any of the above claims, characterized in that the aqueous composition is applied by rolling, flowcoating, knifecoating, spraying, squirting, brushing or dipping and, where appropriate, by subsequent squeezing off with a roll.

37. The method of any of the above claims, characterized in that in each case at least one coating comprising varnish, polymers, paint, adhesives and/or adhesive backing is applied to the partly or completely cured film.

38. The method of any of the above claims, characterized in that the coated metal parts, especially strips or strip sections are formed, painted, coated with polymers such as PVC, for example, printed, bonded, hot-soldered, welded and/or joined to one another or to other elements by clinching or other joining techniques.

39. The method of any of the above claims, characterized in that the strip or the strip sections is/are cut, where appropriate, after painting with a paintlike coating and the painted strip sections during cutting and/or then are formed and thereafter joined, where appropriate, to other shaped parts, in particular by crimping, clinching, adhesive bonding, welding and/or another mechanical joining technique.

40. The method of any of the above claims, characterized in that at least two or three anticorrosion layers are applied in succession, of which each of these two or three layers is an anticorrosion layer selected from the group consisting of coatings based in each case on iron-cobalt, nickel-cobalt, at least one fluoride, at least one complex fluoride, especially tetrafluoride and/or hexafluoride, an organic hydroxy compound, a phosphate, a phosphonate, a polymer, a rare earth compound, including lanthanum and yttrium compounds, a silane/siloxane, a silicate, cations of aluminum, magnesium and/or at least one transition metal selected from the group consisting of chromium, iron, hafnium, cobalt, manganese, molybdenum, nickel, titanium, tungsten, and zirconium, or is a coating based on nanoparticles, but it is also possible where appropriate for at least one further anticorrosion layer to be applied.

41. The method of any of the above claims, characterized in that the first anticorrosion layer is applied in a drying method and in that the second anticorrosion layer is applied in a drying method or rinse method.

42. The method of any of the above claims, characterized in that the first anticorrosion layer is applied by a rinse method and in that the second anticorrosion layer is applied by a drying method or rinse method.

43. The method of any of the above claims, characterized in that the second anticorrosion layer is applied in an afterrinsing step, in particular after the first anticorrosion layer has been applied beforehand on a galvanizing line.

44. The method of any of the above claims, characterized in that the second anticorrosion layer is applied in a drying method, in particular after the first anticorrosion layer has been applied beforehand on a galvanizing line.

45. The method of any of the above claims, characterized in that surfaces of aluminum, iron, cobalt, copper, magnesium, nickel, titanium, tin or zinc or alloys comprising aluminum, iron, cobalt, copper, magnesium, nickel, titanium, tin and/or zinc, especially electrolytically galvanized or hot-dip-galvanized surfaces are coated.

46. The method of any of the above claims, characterized in that coating is carried out with at least one liquid, solution or suspension which is substantially or entirely free from chromium compounds before coating with at least one paint and/or with at least one paintlike polymer-containing layer which comprises polymers, copolymers, crosspolymers, oligomers, phosphonates, silanes and/or siloxanes.

47. The method of any of the above claims, characterized in that no lead, cadmium, chromium, cobalt, copper and/or nickel is added to the liquid, solution or suspension for the first and/or second anticorrosion layer.

48. The method of any of the above claims, characterized in that because of the at least one anticorrosion layer—as compared with the state of the art on the priority date, it is possible in the case of the method of the invention, as compared with the state of the art on the priority date, to forego at least one of the otherwise customary pretreatment layers, paint layers and/or paintlike polymer-containing layers, in particular a pretreatment layer and a paint layer.

49. The method of any of the above claims, characterized in that the liquid, solution or suspension for at least one of the anticorrosion layers and/or paintlike polymer-containing layers comprises, in addition to water, at least one organic film former with at least one water-soluble or water-dispersed polymer, copolymer, block copolymer, crosspolymer, monomer, oligomer, derivative(s) thereof, mixture thereof and/or addition copolymer thereof.

50. The method of any of the above claims, characterized in that the liquid, solution or suspension for at least one of the anticorrosion layers and/or paintlike polymer-containing layers [lacuna], in addition to water, a total content of cations, tetrafluoro complexes and/or hexafluoro complexes of cations selected from the group consisting of titanium, zirconium, hafnium, silicon, aluminum, and boron and/or free or otherwise-bound fluorine, in particular from 0.1 to 15 g/L complex fluoride based on F₆, preferably from 0.5 to 8 g/L complex fluoride based on F₆, or from 0.1 to 1000 mg/L free fluorine.

51. The method of any of the above claims, characterized in that the liquid, solution and/or suspension for at least one of the anticorrosion layers and/or paintlike polymer-containing layers [lacuna], in addition to water, a total content of free fluorine or fluorine not attached to tetrafluoro or hexafluoro complexes, in particular from 0.1 to 1 000 mg/L calculated as free fluorine, preferably from 0.5 to 200 mg/L, more preferably from 1 to 15U mg/L.

52. The method of any of the above claims, characterized in that the liquid, solution or suspension for at least one of the anticorrosion layers, paint layers and/or paintlike polymer-containing layers comprises, in addition to water, at least one inorganic compound in particle form having an average particle diameter, measured under a scanning electron microscope, in the range from 0.003 up to 1 μm diameter, preferably in the range from 0.005 up to 0.2 μm diameter, based in particular on Al₂O₃, BaSO₄, rare earth oxide(s), at least one other rare earth compound, SiO₂, silicate, TiO₂, Y₂O₃, Zn, ZnO and/or ZrO₂, preferably in an amount in the range from 0.1 to 80 g/L, more preferably in an amount in the range from 1 to 50 g/L, very preferably in an amount in the range from 2 to 30 g/L.

53. The method of any of the above claims, characterized in that the liquid, solution or suspension for at least one of the anticorrosion layers, paint layers or paintlike polymer-containing layers [lacuna] at least one corrosion inhibitor selected from the group consisting of organic phosphate compounds, phosphonate compounds, organic morpholine and thio compounds, aluminates, manganates, titanates, and zirconates, preferably of alkylmorpholine complexes, organic Al, Mn, Ti and/or Zr compounds especially of the olefinically unsaturated carboxylic acids, for example, ammonium salt of carboxylic acids such as chelated lactic acid titanate, triethanolamine titanate or triethanolamine zirconate, Zr-4-methyl-γ-oxo-benzyne-butanoic acid, aluminum zirconium carboxylate, alkoxypropenolatotitanate or alkoxypropenolatozirconate, titanium acetate and/or zirconium acetate and/or derivatives thereof, Ti/Zr ammonium carbonate.

54. The method of any of the above claims, characterized in that the liquid, solution or suspension for at least one of the anticorrosion layers, paint layers or paintlike polymer-containing layers comprises at least one compound for the neutralization, in particular the slow neutralization, of comparatively acidic mixtures and/or for the corrosion control of unprotected or damaged portions of the metallic surface, based preferably on carbonate or hydroxycarbonate or conductive polymers, more preferably at least one basic compound with a layer structure such as, for example, Al-containing hydroxy-carbonate hydrate (hydrotalcite).

55. The method of any of the above claims, characterized in that the liquid, solution or suspension for at least one of the anticorrosion layers, paint layers and/or paintlike polymer-containing layers in addition to water comprises at least one silane and/or siloxane, calculated as silane, in particular in an amount in the range from 0.1 to 50 g/L, preferably in an amount in the range from 1 to 30 g/L.

56. The method of any of the above claims, characterized in that the liquid, solution or suspension for at least one of the anticorrosion layers, paint layers and/or paintlike polymer-containing layers in addition to water and/or at least one organic solvent comprises at least one silane and/or siloxane, calculated as silane, in particular in an amount in the range from 51 to 1 300 g/L.

57. The method of any of the above claims, characterized in that the liquid, solution or suspension for at least one of the anticorrosion layers, paint layers and/or paintlike polymer-containing layers where appropriate in addition to water and/or at least one organic solvent comprises at least one silane and/or siloxane, calculated as silane, in particular in an amount in the range from 0.1 to 1 600 g/L, preferably in an amount in the range from 100 to 1 500 g/L.

58. The method of any of the above claims, characterized in that the liquid, solution or suspension for at least one of the anticorrosion layers, paint layers and/or paintlike polymer-containing layers comprises an organic film former in the form of a solution, dispersion, emulsion, microemulsion and/or suspension.

59. The method of any of the above claims, characterized in that the liquid, solution or suspension for at least one of the anticorrosion layers, paint layers and/or paintlike polymer-containing layers comprises as organic film former at least one synthetic resin, in particular at least one synthetic resin based on acrylate, ethylene, polyester, polyurethane, silicone-polyester, epoxide, phenol, styrene, styrene-butadiene, urea-formaldehyde, their derivatives, copolymers, block copolymers, crosspolymers, monomers, oligomers, polymers, mixtures and/or addition copolymers.

60. The method of any of the above claims, characterized in that the liquid, solution or suspension for at least one of the anticorrosion layers, paint layers and/or paintlike polymer-containing layers comprises as organic film former a synthetic resin mixture and/or addition copolymer comprising synthetic resin based on acrylate, ethylene, urea-formaldehyde, polyester, polyurethane, styrene and/or styrene-butadiene and/or their derivatives, copolymers, crosspolyrers, oligomers, polymers, mixtures and/or addition copolymers, from which an organic film is formed during or after the emission of water and other volatile constituents.

61. The method of any of the above claims, characterized in that the liquid, solution or suspension for at least one of the anticorrosion layers, paint layers and/or paintlike polymer-containing layers comprises as organic film former synthetic resins and/or polymers, copolymers, block copolymers, crosspolymers, monomers, oligomers, polymers, mixtures and/or addition copolymers and/or their derivatives based on acrylate, polyethyleneimine, polyurethane, polyvinyl alcohol, polyvinylphenol, polyvinylpyrrolidone and/or polyaspartic acid, especially copolymers with a phosphorus-containing vinyl compound.

62. The method of any of the above claims, characterized in that the liquid, solution or suspension for at least one of the anticorrosion layers, paint layers and/or paintlike polymer-containing layers comprises a synthetic resin whose acid number is in the range from 5 to 250.

63. The method of any of the above claims, characterized in that the liquid, solution or suspension for at least one of the anticorrosion layers, paint layers and/or paintlike polymer-containing layers comprises synthetic resins and/or polymers, copolymers, block copolymers, crosspolymers, monomers, oligomers, polymers, mixtures and/or addition copolymers and/or derivatives thereof whose molecular weights are in the range of at least 1 000 u, preferably of at least 5 000 u or of up to 500 000 u, more preferably in the range from 20 000 to 200 000 u.

64. The method of any of the above claims, characterized in that the liquid, solution or suspension for at least one of the anticorrosion layers, paint layers and/or paintlike polymer-containing layers comprises synthetic resins and/or polymers, block copolymers, copolymers, crosspolymers, monomers, oligomers, polymers, mixtures and/or addition copolymers and/or derivatives thereof, in particular based inter alia on pyrrolidone(s), in particular from 0.1 to 500 g/L, preferably from 0.5 to 30 or from 80 to 250 g/L.

65. The method of any of the above claims, characterized in that the liquid, solution or suspension for at least one of the anticorrosion layers, paint layers and/or paintlike polymer-containing layers comprises an organic film former whose pH in an aqueous formulation without addition of further compounds is in the range from 1 to 12.

66. The method of any of the above claims, characterized in that the liquid, solution or suspension for at least one of the anticorrosion layers, paint layers and/or paintlike polymer-containing layers comprises an organic film former which contains only water-soluble synthetic resins and/or polymers, copolymers, block copolymers, crosspolymers, monomers, oligomers, polymers, mixtures and/or addition copolymers and/or their derivatives, particularly those which are stable in solutions with pH levels≦5.

67. The method of any of the above claims, characterized in that the liquid, solution or suspension for at least one of the anticorrosion layers, paint layers and/or paintlike polymer-containing layers comprises an organic film former whose synthetic resins and/or polymers, copolymers, block copolymers, crosspolymers, monomers, oligomers, polymers, mixtures and/or addition copolymers and/or their derivatives contain carboxyl groups.

68. The method of any of the above claims, characterized in that the liquid, solution or suspension for at least one of the anticorrosion layers, paint layers and/or paintlike polymer-containing layers comprises an organic film former in which the acid groups of the synthetic resins and/or polymers, copolymers, block copolymers, crosspolymers, monomers, oligomers, polymers, mixtures and/or addition copolymers and/or their derivatives have been stabilized with ammonia, with amines such as morpholine, dimethylethanolamine, diethylethanolamine or triethanolamine, for example, and/or with alkali metal compounds such as sodium hydroxide, for example.

69. The method of any of the above claims, characterized in that the liquid, solution or suspension for at least one of the anticorrosion layers, paint layers and/or paintlike polymer-containing layers comprises from 0.1 to 200 g/L and preferably from 0.3 to 50 g/L of the organic film former.

70. The method of any of the above claims, characterized in that the liquid, solution or suspension for at least one of the anticorrosion layers, paint layers and/or paintlike polymer-containing layers comprises from 100 to 2 000 g/L and preferably from 300 to 1 800 g/L of the organic film former.

71. The method of any of the above claims, characterized in that the liquid, solution or suspension for at least one of the anticorrosion layers, paint layers and/or paintlike polymer-containing layers includes a monomer fraction, in particular in the region of at least 5% by weight, preferably of at least 20% by weight, more preferably of at least 40% by weight.

72. The method of any of the above claims, characterized in that the liquid, solution or suspension for at least one of the anticorrosion layers, paint layers and/or paintlike polymer-containing layers comprises from 0.1 to 50 g/L of cations, tetrafluoro complexes and/or hexafluoro complexes of cations selected from the group consisting of titanium, zirconium, hafnium, silicon, aluminum, and boron.

73. The method of any of the above claims, characterized in that the liquid, solution or suspension for at least one of the anticorrosion layers, paint layers and/or paintlike polymer-containing layers comprises at least one organometallic compound, particularly containing titanium and/or zirconium.

74. The method of any of the above claims, characterized in that the liquid, solution or suspension for at least one of the anticorrosion layers, paint layers and/or paintlike polymer-containing layers includes at least one silane and/or siloxane calculated as silane in the aqueous composition, preferably in a range from 0.2 to 40 g/L, more preferably in a range from 0.5 to 10 g/L.

75. The method of any of the above claims, characterized in that the liquid, solution or suspension for at least one of the anticorrosion layers, paint layers and/or paintlike polymer-containing layers comprises at least one partly hydrolyzed silane, at least one wholly hydrolyzed silane and/or at least one siloxane.

76. The method of any of the above claims, characterized in that the liquid, solution or suspension for at least one of the anticorrosion layers, paint layers and/or paintlike polymer-containing layers comprises at least one partly hydrolyzed and/or nonhydrolyzed silane, in particular in the case of a silane content of more than 100 g/L, more preferably in the case of a silane content of more than 1 000 g/L.

77. The method of any of the above claims, characterized in that the liquid, solution or suspension for at least one of the anticorrosion layers, paint layers and/or paintlike polymer-containing layers comprises in each case at least one acyloxysilane, alkylsilane, aminosilane, bis-silyl-silane, epoxysilane, fluoroalkylsilane, glycidyloxysilane, isocyanatosilane, mercaptosilane, (meth)acrylatosilane, mono-silyl-silane, multi-silyl-silane, sulfur-containing silane, ureidosilane, vinylsilane and/or at least one corresponding siloxane.

78. The method of any of the above claims, characterized in that the liquid, solution or suspension for at least one of the anticorrosion layers, paint layers and/or paintlike polymer-containing layers has added to it as inorganic compound in particle form a finely divided powder, a dispersion or a suspension such as, for example, a carbonate, oxide, silicate or sulfate, especially colloidal or amorphous particles.

79. The method of any of the above claims, characterized in that the liquid, solution or suspension for at least one of the anticorrosion layers, paint layers and/or paintlike polymer-containing layers has added to it as inorganic compound in particle form particles having an average size in the range from 4 nm to 150 nm, in particular in the range from 10 to 120 nm.

80. The method of any of the above claims, characterized in that the liquid, solution or suspension for at least one of the anticorrosion layers, paint layers and/or paintlike polymer-containing layers has added to it as inorganic compound in particle form particles based on at least one compound of aluminum, barium, cerium, calcium, lanthanum, silicon, titanium, yttrium, zinc and/or zirconium.

81. The method of any of the above claims, characterized in that to the liquid, solution or suspension for at least one of the anticorrosion layers, paint layers and/or paintlike polymer-containing layers comprises from 0.1 to 300 g/L of the at least one inorganic compound in particle form.

82. The method of any of the above claims, characterized in that the liquid, solution or suspension is used for at least one of the anticorrosion layers, paint layers and/or paintlike polymer-containing layers as organic solvent for the organic polymers at least one water-miscible and/or water-soluble alcohol, one glycol ether and/or one pyrrolidone such as, for example, N-methylpyrrolidone and/or water; where a solvent mixture is used, it is in particular a mixture of at least one long-chain alcohol, such as propylene glycol, for example, an ester alcohol, a glycol ether and/or butanediol with water, but preferably only water without organic solvent.

83. The method of any of the above claims, characterized in that the liquid, solution or suspension for at least one of the anticorrosion layers, paint layers and/or paintlike polymer-containing layers comprises organic solvent in an amount in the range from 0.1 to 10% by weight.

84. The method of any of the above claims, characterized in that the liquid, solution or suspension for at least one of the anticorrosion layers, paint layers and/or paintlike polymer-containing layers comprises as lubricant at least one wax selected from the group consisting of paraffins, polyethylenes, and polypropylenes, in particular an oxidized wax.

85. The method of any of the above claims, characterized in that the liquid, solution or suspension for at least one of the anticorrosion layers, paint layers and/or paintlike polymer-containing layers comprises a wax lubricant whose melting point is in the range from 40 to 160° C., preferably from 0.1 to 100 g/L, more preferably from 20 to 40 g/L or from 0.1 to 10 g/L, very preferably 0.4 to 6 g/L, for example, a crystalline polyethylene wax.

86. The method of any of the above claims, characterized in that the liquid, solution or suspension for at least one of the anticorrosion layers, paint layers and/or paintlike polymer-containing layers comprises at least one rare earth element compound, in particular at least one compound selected from the group consisting of chloride, nitrate, sulfate, sulfamate, and complexes, for example, with a halogen or with an aminocarboxylic acid, in particular complexes with EDTA, NTA or HEDTA, in which context scandium, yttrium, and lanthanum are also regarded as being rare earth elements.

87. The method of any of the above claims, characterized in that the liquid, solution or suspension for at least one of the anticorrosion layers, paint layers and/or paintlike polymer-containing layers comprises a rare earth element compound of and/or with cerium, in particular in a mixture with other rare earth elements, for example, at least partly based on mixed metal.

88. The method of any of the above claims, characterized in that the liquid, solution or suspension for at least one of the anticorrosion layers, paint layers and/or paintlike polymer-containing layers comprises at least one oxidizing agent, in particular a peroxide, at least one accelerator and/or at least one catalyst, preferably a compound and/or ions of Bi, Cu and/or Zn.

89. The method of any of the above claims, characterized in that the liquid, solution or suspension for at least one of the anticorrosion layers, paint layers and/or paintlike polymer-containing layers comprises at least one compound selected from the group of the mono-, bis-, and multi-silanes, especially:
mono-silanes of the general formula SiXₘY₄₋ₘ
with m=1 to 3, preferably m=2 to 3,
with X=alkoxy, especially methoxy, ethoxy and/or propoxy, and
with Y as a functional organic group selected from the group consisting of acyloxy, alkyl, acrylate, amino, epoxy, fluoroalkyl, glycidyloxy, urea, isocyanate, mercapto, methacrylate and/or vinyl and/or derivatives thereof,
bis-silanes of the general formula Y₃₋ₚXₚ—Si-Z-Si—XₙY₃₋ₙ
with p and n=1 to 3, identical or different,
with X=alkoxy, especially methoxy, ethoxy and/or propoxy, and
with Y as a functional organic group selected from the group consisting of acyloxy, alkyl, acrylate, amino, epoxy, fluoroalkyl, glycidyloxy, urea, isocyanate, mercapto, methacrylate and/or vinyl and/or derivatives thereof,
with Z selected from the group of CₙH₂ₙ with n=2 to 20, in each case branched or unbranched, of singly unsaturated alkyl chains of the general formula CₙH₂ₙ₋₂ with n=2 to 20, in each case branched or unbranched, of doubly and/or multiply unsaturated alkyl compounds of the general formulae CₙH₂ₙ₋₄ with n=4 to 20, in each case branched or unbranched, CₙH₂ₙ₋₆ with n=6 to 20, in each case branched or unbranched, or CₙH₂ₙ₋₈ with n=8 to 20, in each case branched or unbranched, of ketones, monoalkylamines, NH, and sulfur S_{q}
with q=1 to 20,
multi-silanes of the general formula Y₃₋ₚXₚ—Si-Z′-SiXₙY₃₋ₙ
with p and n=1 to 3, identical or different,
with X=alkoxy, especially methoxy, ethoxy and/or propoxy, and
with Y as a functional organic group selected from the group consisting of acyloxy, alkyl, acrylate, amino, epoxy, fluoroalkyl, glycidyloxy, urea, isocyanate, mercapto, methacrylate, mono/bis/multi-silyl and vinyl and/or derivatives thereof,
and with Z′=N—Si—XᵣY₃₋ᵣ with r=1 to 3 or sulfur S_{q} with q=1 to 20,
multi-silanes of the general formula Y₃₋ₚXₚ—Si-Z″-Si—XₙY₃₋ₙ with p and n=1 to 3, identical or different,
with X=alkoxy, especially methoxy, ethoxy and/or propoxy, and with Y as a functional organic group selected from the group consisting of acyloxy, alkyl, acrylate, amino, epoxy, fluoroalkyl, glycidyloxy, urea, isocyanate, mercapto, methacrylate, mono/bis/multi-silyl and vinyl and/or derivatives thereof,
and with Z″=-R—C[(SiXₛY₃₋ₛ)(SiXₜY₃₋ₜ)]—R′— or sulfur S_{q} with q=1 to 20,
with s and t=1 to 3, identical or different,
with R and R′, identical or different, selected from the group of CₙH₂ₙ with n=2 to 20, in each case branched or unbranched, of singly unsaturated alkyl chains of the general formula CₙH₂ₙ₋₂ with n=2 to 20, in each case branched or unbranched, of doubly and/or multiply unsaturated alkyl compounds of the general formulae CₙH₂ₙ₋₄ with n=4 to 20, in each case branched or unbranched, CₙH₂ₙ₋₆ with n=6 to 20, in each case branched or unbranched, or CₙH₂ₙ₋₈ with n=8 to 20, in each case branched or unbranched, of ketones, monoalkylamines, and NH,
it being possible for the silanes in each case to be present in hydrolyzed, partly hydrolyzed and/or nonhydrolyzed form in a solution, emulsion and/or suspension.

90. The method of any of the above claims, characterized in that the liquid, solution or suspension for at least one of the anticorrosion layers comprises at least one compound of the type XYZ, X*Y*Z* and/or X*Y*Z*Y*X*,
where Y is an organic group having 2 to 50 carbon atoms,
where X and Z, identical or different, are an OH, SH, NH₂, NHR′, CN, CH═CH₂, OCN, CONHOH, COOR′, acrylamide, epoxide, CH₂═CR″—COO, COOH, HSO₃, HSO₄, (OH)₂PO, (OH)₂PO₂, (OH) (OR′)PO, (OH) (OR′)PO₂, SiH₃ and/or an Si(OH)₃ group,
where R′ is an alkyl group having 1 to 4 carbon atoms,
where R″ is a hydrogen atom or an alkyl group having 1 to 4 carbon atoms, where the groups X and Z are each attached to the group Y in the terminal position thereof,
where Y* is an organic group having 1 to 30 carbon atoms,
where X* and Z*, identical or different, are an OH, SH, NH₂, NHR′, CN, CH═CH₂, OCN, CONHOH, COOR′, acrylamide, epoxide, CH₂═CR″—COO, COOH, HSO₃, HSO₄, (OH)₂PO, (OH)₂PO₂, (OH) (OR′)PO, (OH) (OR′)PO₂, SiH₃, Si(OH) 3, >N—CH₂—PO(OH)₂ and/or an —N—[CH₂—PO(OH)₂]₂ group,
where R′ is an alkyl group having 1 to 4 carbon atoms, and
where R″ is a hydrogen atom or an alkyl group having 1 to 4 carbon atoms.

91. The method of any of the above claims, characterized in that the liquid, solution or suspension for at least one of the anticorrosion layers comprises at least one compound of the type XYZ, where X is a COOH, HSO₃, HSO₄, (OH)₂PO, (OH)₂PO₂, (OH)(OR′)PO or (OH)(OR′)PO₂ group,
where Y is an organic group R containing 2 to 50 carbon atoms, of which at least 60% of these carbon atoms are present in the form of CH₂ groups,
where Z is an OH, SH, NH₂, NHR′, CN, CH═CH₂, OCN, epoxy, CH═CR″—COOH, acrylamide, COOH, (OH)₂PO, (OH)₂PO₂, (OH)(OR′)PO or (OH)(OR″)PO₂ group,
where R′ is an alkyl group having 1 to 4 carbon atoms, and where R″ is a hydrogen atom or an alkyl group having 1 to 4 carbon atoms, preferably in total from 0.01 to 10 g/L, preferably from 0.05 to 5 g/L, very preferably from 0.08 to 2 g/L.

92. The method of any of the above claims, characterized in that the compound of type XYZ, X*Y*Z* and/or X*Y*Z*Y*X* is suitable for forming self-arranging molecules, which may shape a layer of these self-arranging molecules particularly on the metallic surface, preferably a monomolecular layer.

93. The method of any of the above claims, characterized in that the liquid, solution or suspension for at least one of the anticorrosion layers comprises at least one of the following compounds of type XYZ, X*Y*Z* and/or X*Y*Z*Y*X*:
1-phosphonic acid-12-mercaptododecane,
1-phosphonic acid-12-(N-ethylaminododecane),
1-phosphonic acid-12-dodecene,
p-xylylenediphosphonic acid,
1,10-decanediphosphonic acid,
1,12-dodecanediphosphonic acid,
1,14-tetradecanediphosphonic acid,
1-phosphoric acid-12-hydroxydodecane,
1-phosphoric acid-12-(N-ethylamino)dodecane,
1-phosphoric acid-12-dodecene,
1-phosphoric acid-12-mercaptododecane,
1,10-decanediphosphoric acid,
1,12-dodecanephosphoric acid,
1,14-tetradecanediphosphoric acid,
p,p′-biphenyldiphosphoric acid,
1-phosphoric acid-12-acryloyldodecane,
1,8-octanediphosphonic acid,
1,6-hexanediphosphonic acid,
1,4-butanediphosphonic acid,
1,8-octanediphosphoric acid,
1,6-hexanediphosphoric acid,
1,4-butanediphosphoric acid,
aminotrimethylenephosphonic acid,
ethylenediaminetetramethylenephosphonic acid,
hexamethylenediaminetetramethylenephosphonic acid,
diethylenetriaminepentamethylenephosphonic acid,
2-phosphonobutane-1,2,4-tricarboxylic acid.

94. The method of any of the above claims, characterized in that at least one of the liquids, solutions or suspensions for at least one of the anticorrosion layers and/or paintlike polymer-containing layers comprises phosphate and zinc, where appropriate also manganese, nickel and/or copper.

95. The method of any of the above claims, characterized in that at least one of the liquids, solutions or suspensions for at least one of the anticorrosion layers and/or paintlike polymer-containing layers contains from 0.2 to less than 50 g/L zinc ions, from 0.5 to 45 g/L manganese ions, and from 2 to 300 g/L phosphate ions, calculated as P₂O₅.

96. The method of any of the above claims, characterized in that at least one of the liquids, solutions or suspensions for at least one of the anticorrosion layers and/or paintlike polymer-containing layers comprises phosphate, preferably based on Zn or ZnMn, where appropriate with nickel content.

97. The method of any of the above claims, characterized in that at least one of the liquids, solutions or suspensions for at least one of the anticorrosion layers, paint layers and/or paintlike polymer-containing layers comprises phosphate, fluoride, tetrafluoride and/or hexafluoride.

98. The method of any of the above claims, characterized in that at least one of the liquids, solutions or suspensions for at least one of the anticorrosion layers, paint layers and/or paintlike polymer-containing layers may comprise phosphonate, tetrafluoride and/or hexafluoride.

99. The method of any of the above claims, characterized in that at least one of the liquids, solutions or suspensions for at least one of the anticorrosion layers, paint layers and/or paintlike polymer-containing layers comprises an organic film former, fluoride, tetrafluoride, hexafluoride and/or at least one inorganic compound in particle form, and, where appropriate, at least one silane.

100. The method of any of the above claims, characterized in that at least one of the liquids, solutions or suspensions for at least one of the anticorrosion layers, paint layers and/or paintlike polymer-containing layers comprises an additive selected from the group consisting of organic binders, biocides, defoamers, corrosion inhibitors, adhesion promoters, wetting agents, photoinitiators, and polymerization inhibitors.

101. The method of any of the above claims, characterized in that at least one of the liquids, solutions or suspensions for at least one of the anticorrosion layers, paint layers and/or paintlike polymer-containing layers comprises at least one filler and/or one pigment, in particular at least one electrically conductive pigment selected from the group consisting of dyes, color pigments, graphite, graphite-mica pigments, oxides such as iron oxides, phosphates, phosphides such as iron phosphides, carbon black and zinc.

102. The method of any of the above claims, characterized in that prior to the application of an anticorrosion layer, paint layer and/or paintlike polymer-containing layer, an activating treatment is applied.

103. The method of any of the above claims, characterized in that the application of an anticorrosion layer, paint layer or paintlike polymer-containing layer may be followed by application of an afterrinse and/or passivation.

104. The method of any of the above claims, characterized in that at least one of the liquids, solutions or suspensions for at least one of the anticorrosion layers, paint layers and/or paintlike polymer-containing layers comprises an organic film former which, following application to the metallic substrate, is cured by heat and/or actinic radiation, in particular by electrons, UV and/or radiation in the visible light region.

105. The method of any of the above claims, characterized in that at least one of the anticorrosion layers, paint layers and/or paintlike polymer-containing layers may be only partly cured prior to adhesive bonding, welding, and/or forming and not fully cured until after adhesive bonding, welding and/or forming, the first curing before adhesive bonding, welding and/or forming taking place by actinic radiation—in particular by electrons, UV and/or radiation in the visible light region—and the second curing taking place after adhesive bonding, welding and/or forming, preferably thermally, in particular by radiant heat and/or hot air.

106. The method of any of the above claims, characterized in that the liquid, solution or suspension for at least one of the anticorrosion layers, paint layers and/or paintlike polymer-containing layers has a pH in the range from 0.5 to 12.

107. The method of any of the above claims, characterized in that the liquid, solution or suspension for at least one of the anticorrosion layers, paint layers and/or paintlike polymer-containing layers is applied to the respective surface at a temperature in the range from 5 to 95° C., preferably in the range from 5 to 50° C.

108. The method of any of the above claims, characterized in that the substrate and/or the respective surface are held during application of the anticorrosion layer(s) at temperatures in the range from 5 to 120° C.

109. The method of any of the above claims, characterized in that the coated metallic surface in this case is dried at a temperature in the range from 20 to 400° C. PMT (peak metal temperature).

110. The method of any of the above claims, characterized in that the coated strips are cut up or wound to a coil, where appropriate after cooling to a temperature in the range from 10 to 70° C.

111. The method of any of the above claims, characterized in that the divided strips, after pressing, cutting and/or punching, are coated in the edge region with a temporarily applied coating to be removed again or with a permanently protecting coating, e.g., at least one coating based on dry lubricant, phosphate, hexafluoride, paintlike coating and/or paint.

112. The method of any of the above claims, characterized in that the liquid, solution or suspension for at least one of the anticorrosion layers, paint layers and/or paintlike polymer-containing layers is applied by rolling, flowcoating, knifecoating, spraying, squirting, brushing or dipping and, where appropriate, by subsequent squeezing off with a roll.

113. The method of any of the above claims, characterized in that the coating applied in each case with the liquid, solution or suspension for at least one of the anticorrosion layers, paint layers and/or paintlike polymer-containing layers is adjusted to a layer weight in the range from 0.0005 mg/m² to 150 g/m², preferably in the range from 0.0008 mg/m² to 30 g/m², more preferably in the range from 0.001 mg/m² to 10 g/m², in particular in the range from 1 to 6 g/m².

114. The method of any of the above claims, characterized in that to the partly or fully cured film there is applied in each case at least one coating of paint or of a paintlike, polymer-containing coating to the partly or fully cured film, the first paint layer or paintlike polymer-containing layer may consist essentially of primer, a thinly (i.e., in the range from 0.1 to 10 μm) applied, organic-polymer-containing material, a reaction primer, a shop primer or a wash primer.

115. The method of any of the above claims, characterized in that at least one coating of paint, a mixture of or with polymers, varnish, adhesive and/or adhesive backing is applied to the at least partly painted strip or the strip at least partly coated in a paintlike manner with a polymer-containing layer, or to the at least partly painted strip section or the strip section coated at least partly in a paintlike manner with a polymer-containing layer.

116. The method of any of the above claims, characterized in that the clean or cleaned and, where appropriate, activated metallic surface is contacted with the liquid, solution or suspension for one of the anticorrosion layers and at least one film, which where appropriate may also contain particles, may be formed on the metallic surface, which is subsequently dried and, where appropriate, additionally cured, the dried and, where appropriate, also cured film possibly having in each case a thickness in the range from 0.01 to 100 μm, in particular a film with a thickness in the range from 5 up to 50 μm, more preferably in the range from 8 up to 30 μm.

117. The method of any of the above claims, characterized in that at least one paint layer as undercoat or one paintlike polymer-containing layer as pretreatment primer, primer, primer as replacement of the cathodic dip coat, lubricating primer, reaction primer, welding primer, wash primer, clearcoat and/or topcoat, where appropriate instead of an undercoat, is applied.

118. The method of any of the above claims, characterized in that at least one of the paint layers and/or paintlike polymer-containing layers is cured by heat and/or actinic radiation, in particular by UV radiation.

119. The method of any of the above claims, characterized in that the coated strips or strip sections are formed, painted, coated with polymers such as PVC, for example, printed, bonded, hot soldered, welded and/or joined with one another or with other elements by clinching or other joining techniques.

120. Use of the substrates coated by the method of at least one of the above claims 1 to 119, such as, for example, a wire, a strip or a part, characterized in that the substrate to be coated is wire winding, wire mesh, steel strip, metal sheet, paneling, shield, vehicle body or part of a vehicle body, part of a vehicle, trailer, recreational vehicle or missile, cover, casing, lamp, light, traffic light element, furniture item or furniture element, an element of a household appliance, frame, profile, molding of complex geometry, guideboard element, radiator element or fencing element, bumper, part of or with at least one pipe and/or profile, window frame, door frame or cycle frame, or a small part such as, for example, a bolt, nut, flange, spring or a spectacle frame.

121. The use of the products produced by the method of at least one of claims 1 to 119 in vehicle construction, in particular in automotive production-line manufacture, for producing components or bodywork parts or premounted elements in the vehicle, air travel or space travel industry; as metal sheet, paneling, bodywork or part of a bodywork, as part of a vehicle, trailer, recreational vehicle or missile, as a cover, profile, shaped part of complex geometry, bumper, part of or with at least one pipe and/or profile.
